(19) United States
(12) Patent Application Publication
(10) Pub. No.: US 2005/0131625 A1
(43) Pub. Date: Jun. 16, 2005

(54) Schoolchildren transportation management systems, methods and computer program products

(76) Inventors: Alexander B. Birger, Raleigh, NC (US); James C. Turner, Concord, NC (US); Thomas G. Zwirblia, Garner, NC (US); Dmitry Ivanov, Raleigh, NC (US)

Correspondence Address: Alexander Birger, 2800 London Bell Dr., Raleigh, NC, 27614, US

(21) Appl. No.: 10/988,138

(22) Filed: Nov. 15, 2004

Related U.S. Application Data
(60) Provisional application No. 60/523,253, filed on Nov. 19, 2003.

(51) Int. Cl. G08G 1/00

(52) U.S. Cl. 701/117; 340/994

(57) ABSTRACT

Millions of schoolchildren take a ride to and from school on buses every day. Quite frequently we hear about multiple problems with the school buses. The school bus did not arrive on time, the bus did not show up at all, or the time or place of a bus stop has changed without notification—all these problems are unfortunately very common. Today's School Transportation systems do not always work as fast and as reliably as it is reasonably expected. These systems use phone or fax-based communication. These methods are slow, inefficient, and can be catastrophic since children's safety is on the line. Online Schoolchildren Transportation Management Method, System, and Computer Program Products, store data and provide real-time communication between the main participants of the schoolchildren transportation process: school transportation officers, district, county and/or state transportation management, schoolchildren and/or parents, and/or school bus drivers via a Web based network. Embodiments of the present invention allow efficient and streamlined communications between the main participants of the School Children Transportation Process to solve the following: Student's Transportation Change Request and Response; Transportation Information Lookup and Reporting in Real-Time; Transportation Emergencies and Exceptions; Bus Stop Location Change/Addition; Automatic Request/Response Notification Flow; Bus Arrival/Departure information; Management Reporting; Field Trips Request; Special Needs/Handicapped, Front Desk/Call Center Operator and etc. The new system (method, computer program) provides a framework for uniform and standardized information exchange between System Participants, thus guarantying uniform data collection, processing and reporting and opening numerous additional benefits to further utilization of the collected data.

Current Application claims the benefits of Provisional Patent Application No. 60/523,253 of Nov. 19, 2003 with the same title and inventor names.

### BACKGROUND

Today's School Transportation systems do not always work as fast and as reliably as it is reasonably expected. These systems use phone or fax-based communication. This may equally pertain to bus routes, bus stops locations and times, student to bus stop assignments in the morning and in the afternoon, and/or to any transportation changes.

A current schedule may be manually updated and may only be available as a printed hard copy. That copy may be sent to schools once in the beginning of the school semester, and it may be practically obsolete by the time it is delivered to schools and parents since many changes and adjustments may happen within the first few weeks of school.

The District Managers may do a great job communicating and working with Assistant Principles and Parents to attempt to ensure that no child is left behind, but the lack of basic information management tools may lead to an information shortage. The conventional process for making changes to a student's bus stop assignment is through a paper form that is filled out and faxed to the District Manager, Every school may come up with its own version of the form, so the collected information is extremely dispersed and non-uniform. The responses are-sent back via fax or US Mail from District Manager to Assistant Principle and parents.

These methods are slow, inefficient, and can be catastrophic since children's safety is on the line.

### SUMMARY OF THE INVENTION

Some embodiments of the invention, also referred to herein as an online Schoolchildren Transportation Management System, store data and provide real-time communication between the main participants of the schoolchildren transportation process. Embodiments of the present invention can allow efficient and streamlined communications between the main participants of the School Children Transportation Process.

Embodiments of the invention can provide benefits such as, but not limited to one or more of the following:
Preventing or reducing the chances of children being sent to the wrong bus, not being picked up at the stop, being picked up at the wrong time, being delivered to the wrong place, and etc.
Increasing safety, convenience, and reducing parental complaints.
Keeping everyone in the process more informed, thereby saving everyone a lot of time and frustration.
Reducing stress and workload of school administrators and bus transportation managers by giving them productivity tools allowing efficient and smooth error-free day-today operation.
Providing participants with better information and tools to handle emergency situations.
Providing School Officials with up-to-date traffic and schedule related information that may not otherwise be easily available.
Providing the Management of the School Transportation District/County/State with valuable information and tools to efficiently measure performance of School District metrics (Dispatchers, Bus Drivers) to improve overall District performance

### BRIEF DESCRIPTION OF THE DRAWINGS

FIG. 1. System Components Diagram.

FIG. 2. Transportation Change Request Queue. Current Embodiment.

FIG. 3. Transportation Change Request Form for existing student. Current Embodiment.

FIG. 4. Transportation Change Request Form for new student. Current Embodiment.

FIGS. 35 through 45. Database schema.

### FLOWCHARTS

1) Transportation Change Request and Response
1a) General Request Flow FIG. 5.
1b) New Student Request Flow FIG. 6.
1c) Existing Student Request Flow FIG. 7.
1f) Request Status Check Flow FIG. 8.
1g) Request Modification or Cancellation Flow FIG. 9.
1h) Request Approval/Denial Flow FIG. 10.
1k) Request Appeal Flow FIG. 11.

2) Bus Schedule, Bus Routes, Bus Stop and Student Assignment Lookup
2a) Bus Route and Schedule Lookup Flow FIG. 12.
2b) Bus Stops and Student Assignment Lookup by Route Flow FIG. 13.
2c) Bus Stops and Student Assignment Lookup by Student Name Flow FIG. 14.
2d) Bus Status/Delays/Emergencies Lookup Flow FIG. 15.

3) Transportation Emergencies and Exceptions
3a) Bus Delay or Brake Down Information Entry Flow FIG. 16.
3b) Bus Unexpected Detour Information Entry Flow FIG. 17.
3c) School Bus Involved into Traffic Accident Information Entry Flow FIG. 18.

4) Bus Stop Location Change/Addition
4a) Bus Stop Location Change/Addition Flow FIG. 19.
4b) Bus Schedule/Student Assignment Change Automatic Notification Flow FIG. 20.

5) Automatic Request/Response Notification Flow
5a) Automatic Request Notification Flow FIG. 21.
5b) Automatic Response Notification to [TDAP],[TDSP],[TDBD] flow. FIG. 22.

6) Bus Arrival/Departure Information
6a) Bus Arrival/Departure Information Entry Flow FIG. 23.
6b) Bus Arrival/Departure Information Lookup Flow FIG. 24.

7) Management Reporting
7a) Bus Driver Performance Reporting Flow FIG. 26.
7b) District Management Performance Reporting Flow FIG. 25.

8) Field Trips Request
8a) Field Trip Request Flow FIG. 27.
8b) Field Trip Request Approval/Denial Flow FIG. FIG. 28.
8c) Field Trip Request Status Check Flow FIG. 29.

9) Special Needs/Handicapped
9a) Special Needs/Handicapped Request Flow FIG. 30.
9b) Special Needs/Handicapped Request Approval/Denial Flow FIG. 31.
9c) Special Needs/Handicapped Request Status Check Flow FIG. 32.
9d) Special Needs/Handicapped Special Needs Coordinator Approval FIG. 33.

10) Front Desk/Call Center Operator
10a) Incoming Call and Miscellaneous Request Processing Flow FIG. 34.

### DESCRIPTION OF THE INVENTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The present invention is described below with reference to block diagrams and/or flowchart illustrations of methods, apparatus (systems) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

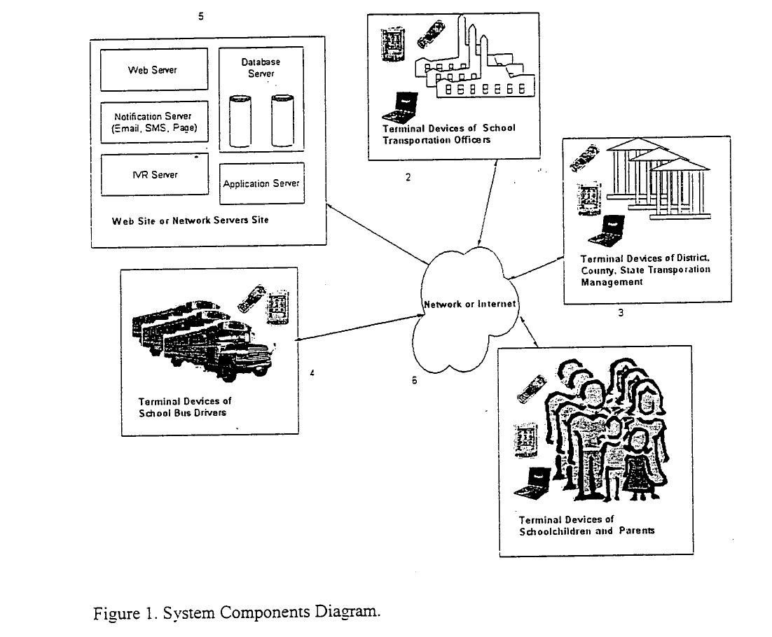

Referring to FIG. 1, a block diagram of systems, methods and/or computer program products, according to some embodiments of present invention, is schematically illustrated. These embodiments include a Server Website or Network Servers Site [5] and a plurality of client terminal devices [1], [2], [3], [4] connected to a Server Site [5] via a computer network [6], such as Internet. The Server Website or Network Server Site [5] may be embodied as one or more personal, application, enterprise, pervasive and/or embedded computer systems that may be linked via a wired and/or wireless, private and/or public network. Moreover, the functionality shown in the blocks of Block [5] may each be embodied in one or more personal, application, enterprise, pervasive and/or embedded computing device. The functionality shown in the individual blocks of Block [5] may also be merged and/or combined in a centralized environment and/or distributed in a distributed environment.

The terminal devices of Blocks [1], [2], [3] or [4] may be embodied as a wireless and/or wired terminal. The wired terminal may include a workstation. The wireless terminals may include cellular and/or satellite radiotelephones, Personal Communications System (PCS) terminals that may combine a cellular radiotelephone with data processing, facsimile and/or data communications capabilities, Personal Digital Assistants (PDA) that can include a radio frequency transceiver and a pager, Internet/intranet access, Web browser, organizer, calendar and/or a global positioning system (GPS) receiver, and/or conventional laptop and/or palmtop computers or other appliances, which include a radio frequency receiver.

Additional details of some embodiments of FIG. 1 now will be provided.

The server Web Site or Network Servers Site [5] may include multiple computers running a set of server applications such as but not limited to
Web Server (5a), such as Microsoft Internet Information Server 5.0
Database Server (5b), such as Microsoft SQL Server 2000 or Oracle 8
Notification Server (5c)
Interactive Voice Response (IVR) Server (5d)
Reporting Server (5e)
Application Server (5f).

Each of these applications may be responsible for processing a specific set of tasks. Specific implementation might vary in wide ranges. Although a single server of each type is shown on FIG. 1, multiple servers of each type might comprise the Server Site.

The Web Server (5a) is configured to support two-way communication, for example via HTTP or secure HTTPS protocols to the browsers running on client terminal devices.

The Database Server (5) is responsible for storing information used by the system, such as the data about transportation process participants, transportation change requests, schools, school bus routes and runs, bus stops, student assignments to bus stops, schedules and/or other data for system operation.

The Notification Server (5) is configured to support messaging and notification activities, such as emails, SMS messages, messages to pagers etc. the Notification Server can also generate postal correspondence delivered via US Mail or other commercial mail carriers.

The IVR Server (5d) is responsible for two-way communication via public telephone lines, with the clients using phones as terminal devices. The IVR Server can use Text-to-Speech technology for outbound information and Speech Recognition or Touch Tone for inbound information.

The Reporting Server (5e) is used to generate reports and deliver them to recipients.

The Application Server (5f) can run miscellaneous support and utility programs.

The client terminal devices [1],[2],[3],[4] of transportation process participants can exchange information with Server Site via Network [6]. The network [6] may include one or more wired and/or wireless public and/or private networks. An example of a client terminal device may be a computer running a client program, such as Microsoft Internet Explorer, communicating with the Web Server on the Server Site [5] via encrypted protocol like HTTPS. It is understood that other electronic devices such as personal digital assistants (PDAs), hand-held computers, cell phones, WebTVs, faxes, pagers and telephones might be used. In an alternative example, analog telephones can be used as client terminal devices of transportation participants, where these telephones are linked via public telephone network to the Interactive Voice Response (IVR) Server on the Server Side equipped with Text-to-Speech and Speech Recognition features. The following examples of client terminal devices are represented in FIG. 1:
[1]—terminal device of school children or school children's parents, [TDSP].
[2]—terminal device of school transportation officers, such as Assistant Principals, [TDAP].
[3]—terminal device of district, county, state transportation management, such as School District Transportation Manager [TDDM] or County's School Transportation Administrator or Superintendent [TDDA].
[4]—terminal device of school bus drivers [TDBD].

Although the term “terminal device” is used in this description, it is understood that these devices need not necessarily operate as “dumb terminals” and the software which operates on these client devices can carry a share of business logic. In various embodiments of this system they can be implemented either as “thin client” or as “thick client”. In the last case, a significant part of business logic and data processing may actually happen on the client device, while in the first case almost all of the logic and processing may occur on the servers.

The network [6] linking server site with client terminal devices can be any type of computer network including but not limited to one or more of the following:
Internet
Private Network
Wireless Network
Public or Private Telephone Network

Additional types of client terminal devices and peripheral devices can be connected to the network, for example printers and faxes.

Functionality may be provided according to various embodiments of the invention, as one or more of the following:
Transportation Change Request and Response
Transportation Information Lookup and Reporting in Real Time
Transportation Emergencies and Exceptions
Bus Stop Location Change/Addition
Automatic Request/Response Notification Flow
Bus Arrival/Departure Information
Management Reporting
Field Trips Request
Special Needs/Handicapped.

Combinations and sub combinations of these and/or other functions may be provided. Moreover, in some embodiments, some or all of these functions may overlap or merge, at least in part. The following sections will describe these functions in more detail, according to some embodiments of the present invention.

Transportation Change Request and Response.

Some embodiments of the Invention can provide a set of methods and operations enabling efficient communication between the participants of the School Children Transportation Process. This communication may be implemented in terms of requests, which are typically sent from the school transportation officers or from school children's parents to the district, state or county transportation officials. Operations will be described implementing the Transportation Change Request life cycle according to some embodiments. Transportation Change Request processing stages according to some embodiments include, but are not limited to, the following: generation, prioritizing, queuing, processing, approval, denial, appeal, re-routing, maintenance, archiving.

In Flowchart 1a, a general flow of Transportation Change Request and Response according to some embodiments of the present invention is illustrated. Examples of Transportation Change Request are as follows: request to place a student on a bus route/run, add a stop to a bus route/run, change the position of the stop, change the schedule of the bus, assign or un-assign a student to/from bus route, remove the bus stop, bus run, bus route etc. In many situations such requests will be generated from [TDSP] (see 1a.1) or [TDAP] (1a.2), but it is understood that a Transportation Change Request can be also originated from [TDBD], [TDDM], or [TDDA]. In many typical scenarios, the request would be generated from [TDAP] or from [TDSP], and in the last case it will be routed by the system to [TDAP]. Additional information may be added at [TDAP] (see 1a.3), such as but not limited to address or name corrections, grade, school and student identification information, special transportation instructions, school-specific instructions to the bus driver, desired timing of the request implementation, priority information, justification for the request urgency, labels identifying temporary or on-time requests vs. permanent assignments and/or miscellaneous comments related to this request. After that request will be routed to [TDDM] (1a.5). In other situations, the request will be generated at [TDSP] and then routed to [TDDM] directly, or generated from [TDDM] based on a phone call, fax, email etc. (1a.4). Open requests are prioritized and queued by the system based on the current set of business rules (1a.7).

According to block 1a.8, the requests are presented to and processed at [TDDM]. A Transportation Change Request can be approved, denied, postponed or marked as pending (1a.9). With approval of the request, a bus schedule, bus route, runs of the bus route, bus stop location and/or student-to-stop assignment information is likely to be changed by the system. When such changes occur, the system records those to the database (1a.11) and forwards the approved request with the comments to the originator of the request (1a.13). If the request is denied, the comments to the denied request can be added from [TDDM] , for example to explain the reason of denial to request originator (1a.10), and then again the denied request is routed back to the originator (1a.12). In this case the originator may have an option to send an appeal request (1a.14, 1a.6), which is re-queued after submission by the system for subsequent processing by [TDDM].

The postponed and pending requests remain in the processing queue until they are processed. If business rules are configured in the system, the past-due requests can be automatically re-prioritized, archived and/or the notification about the past due requests can be sent to appropriate parties. The approved and denied requests can be automatically archived by the system after they have been reviewed by originators and/or archiving can be triggered by the user from one of the client devices (1a.15).

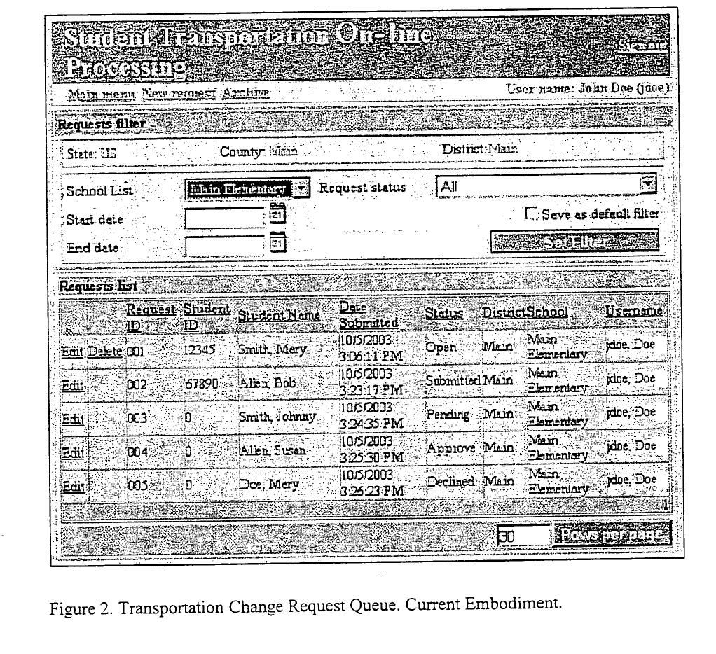

A Transportation Change Request queue according to some embodiments of this invention is shown at FIG. 2.

Flowcharts 1b and 1c provide additional details of operations for Transportation Change Request Creation for new students and existing students, respectively. Both operations are originated with logging in of one of school children transportation process participants to their client terminal device (1b.1, 1b.2, 1b.3, 1c.1, 1c.2, 1c.3). Although only [TDSP], [TDAP], and [TDDM] are shown on the flowchart, the Transportation Change Request can be originated from the device of any participant of school children transportation process as long as it is allowed by business rules. When the request for the new student is created, there is no previous information about the new student in the database. Therefore, the request form for new student (1b.4, 1b.5, 1b.6) may include more information versus a request form for the existing student, data about whom is already present in the database (1c.7, 1c.8, 1c.9). After the request form is filled, the comment(s) with additional information can be attached to the request (1b.7, 1b.8, 1c.10, 1c.11), such as but not limited to school and student additional identification information, special transportation instructions, school-specific instructions for the bus driver, desired timing of the request implementation, priority information, justification for the request urgency, labels identifying temporary or on-time requests vs. permanent assignments and/or any other miscellaneous comments related to this request, then the request is saved and submitted to the transportation official of district, county or state (1b.10, 1b.11, 1c.13, 1c.14).

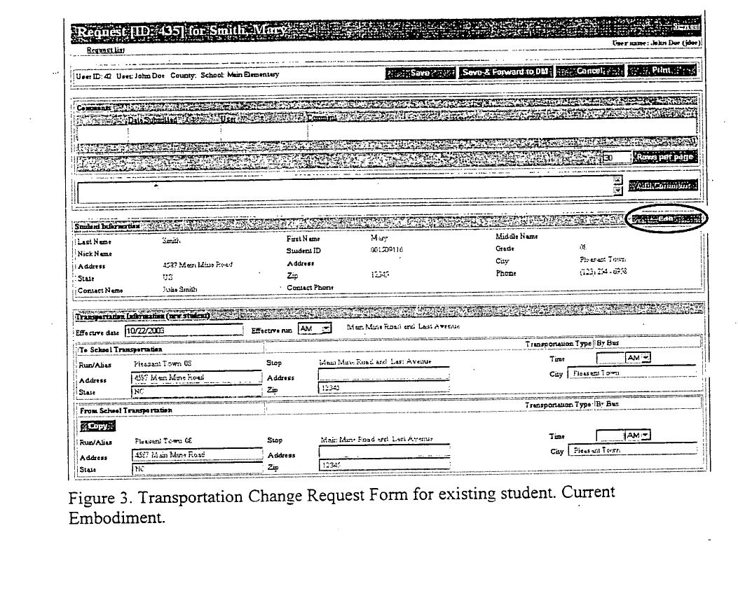

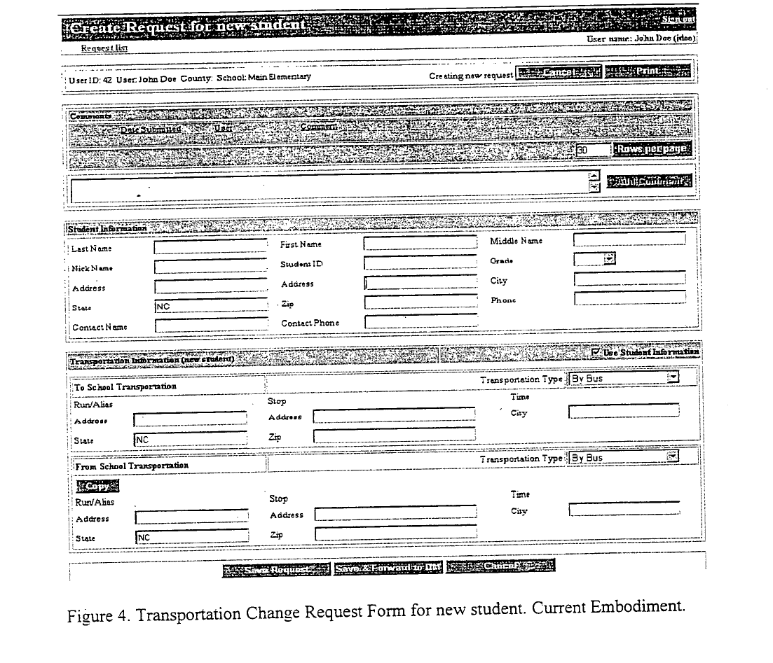

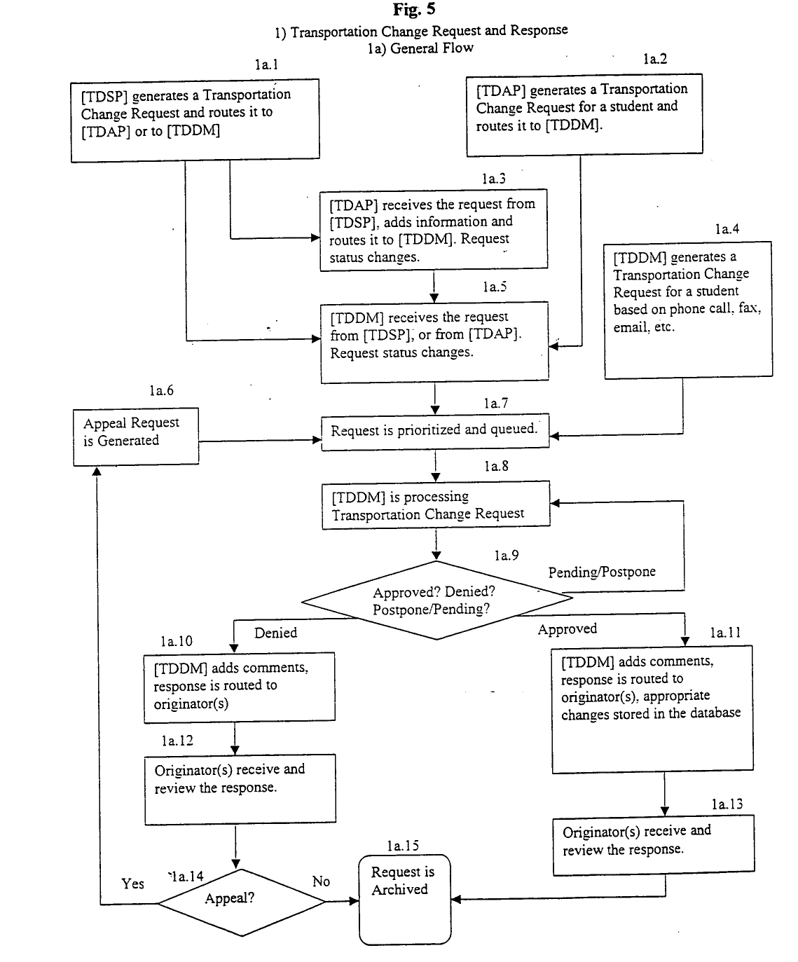

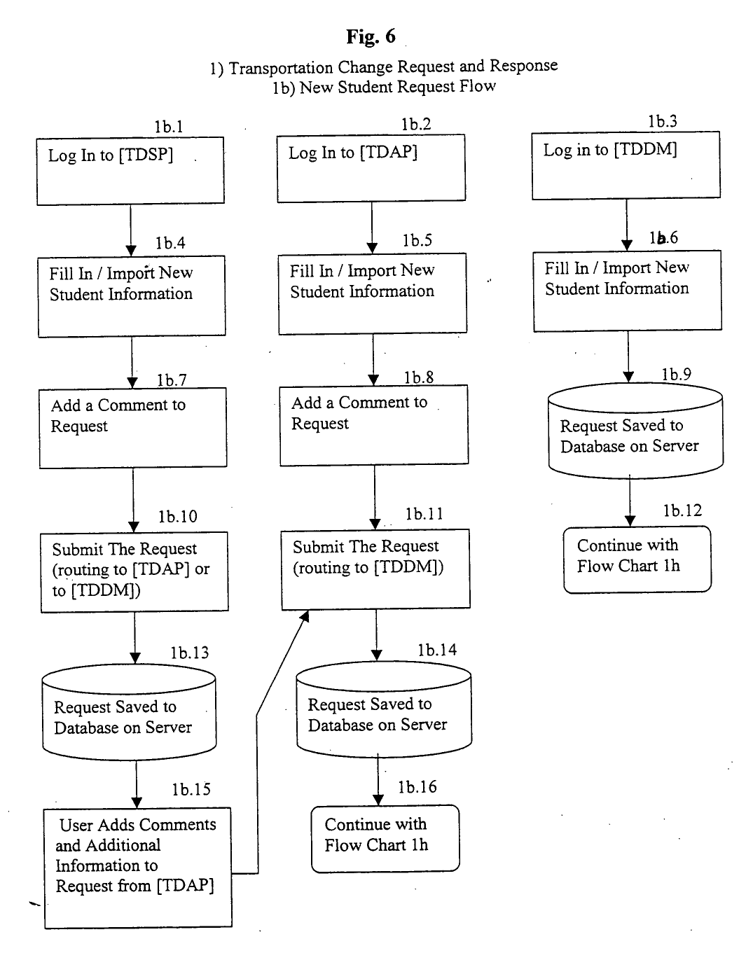

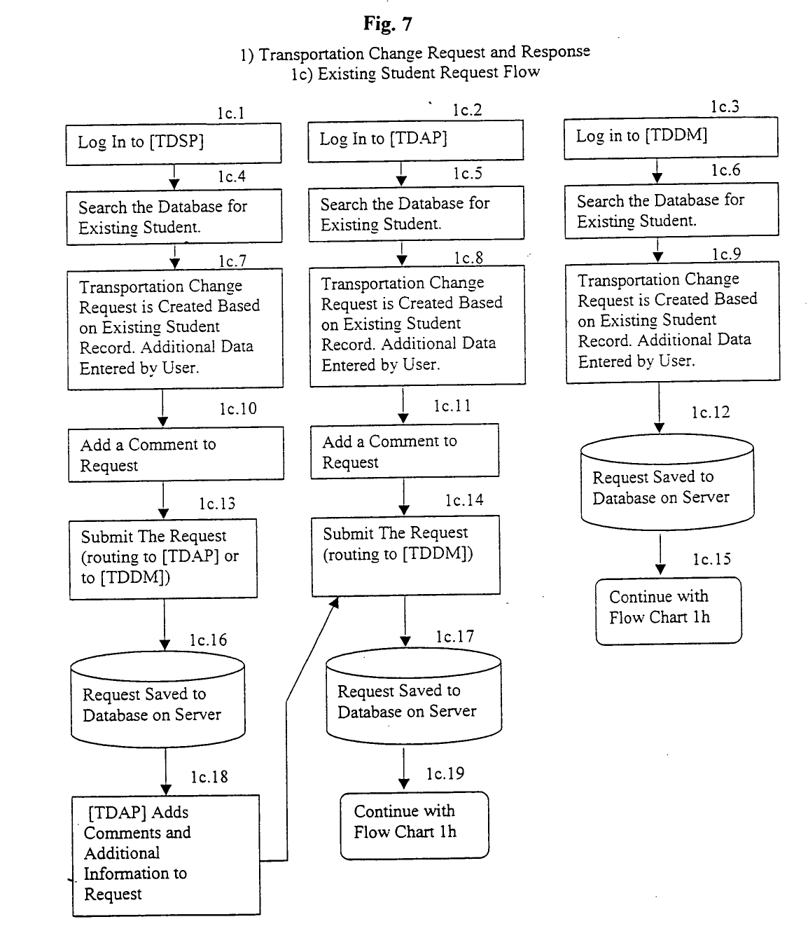

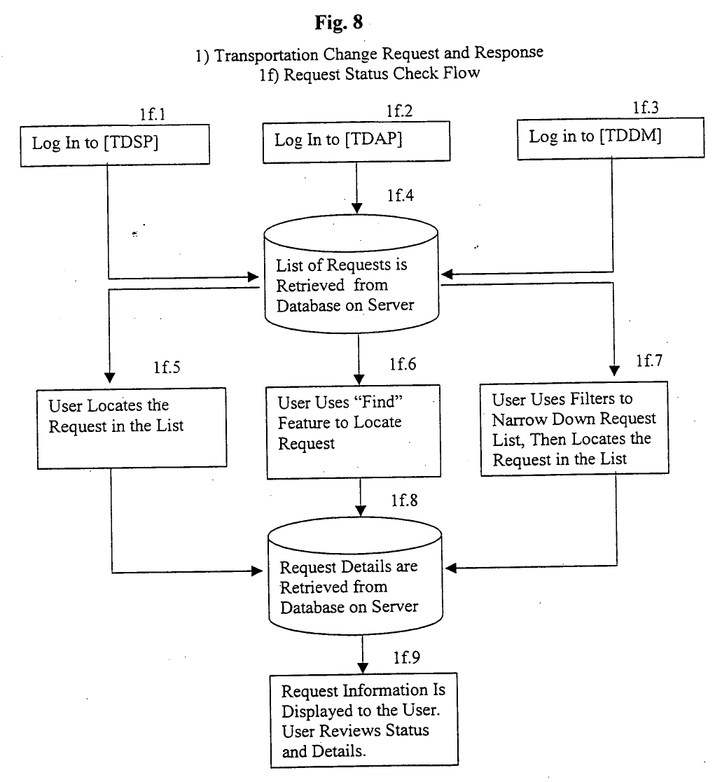

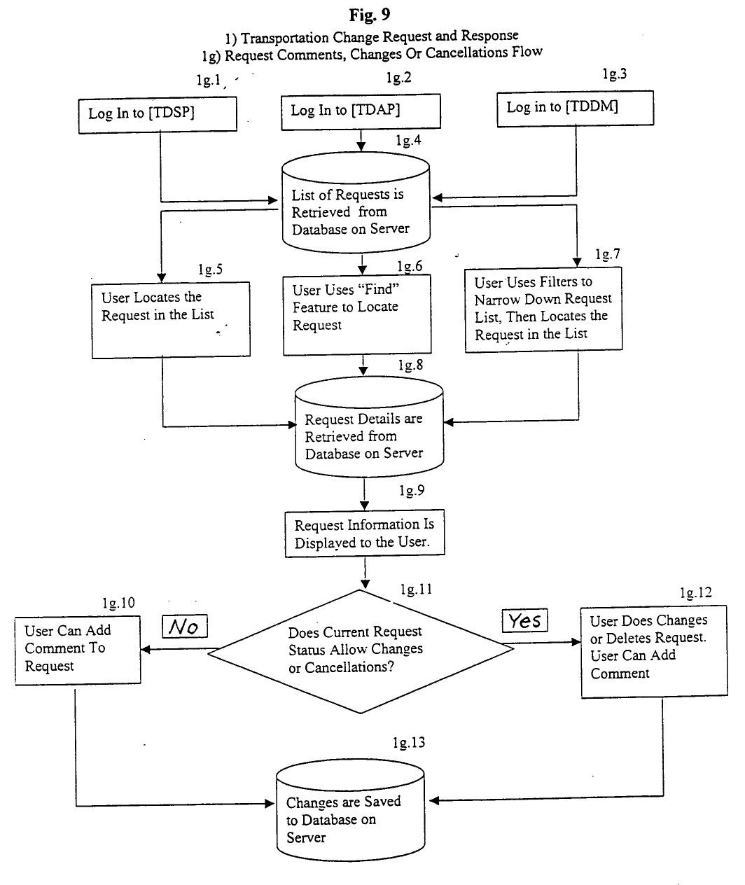

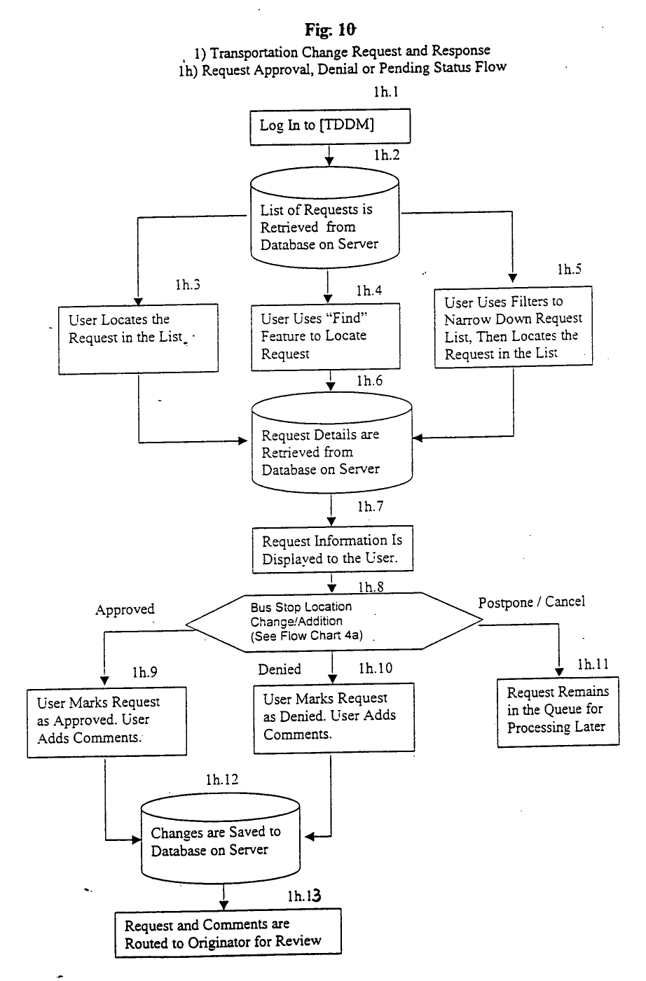

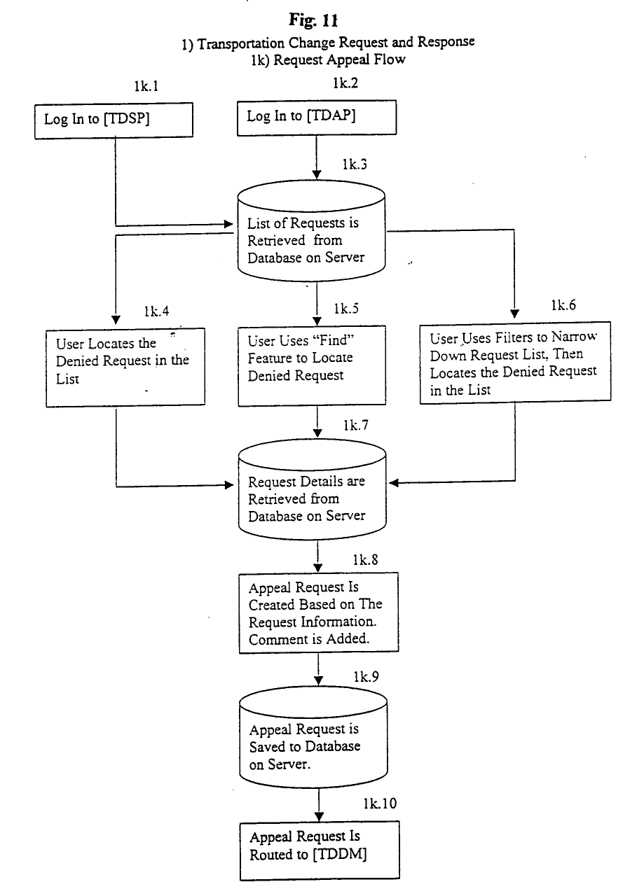

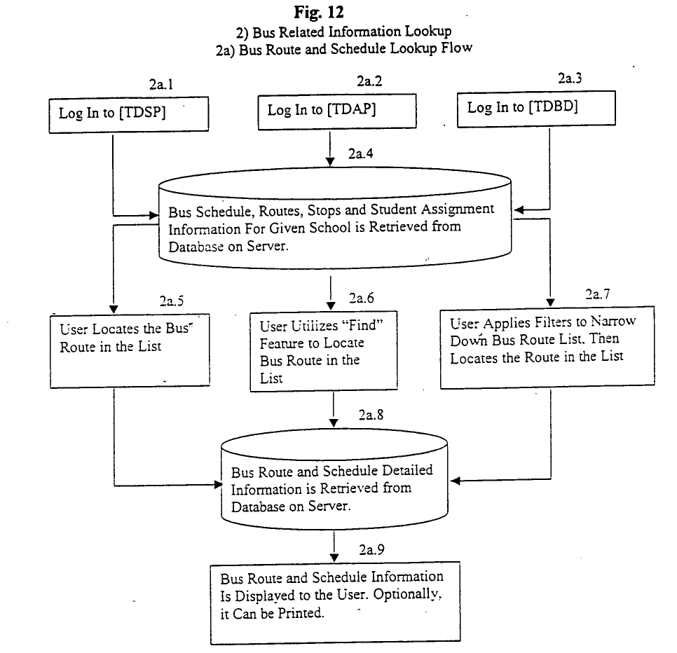

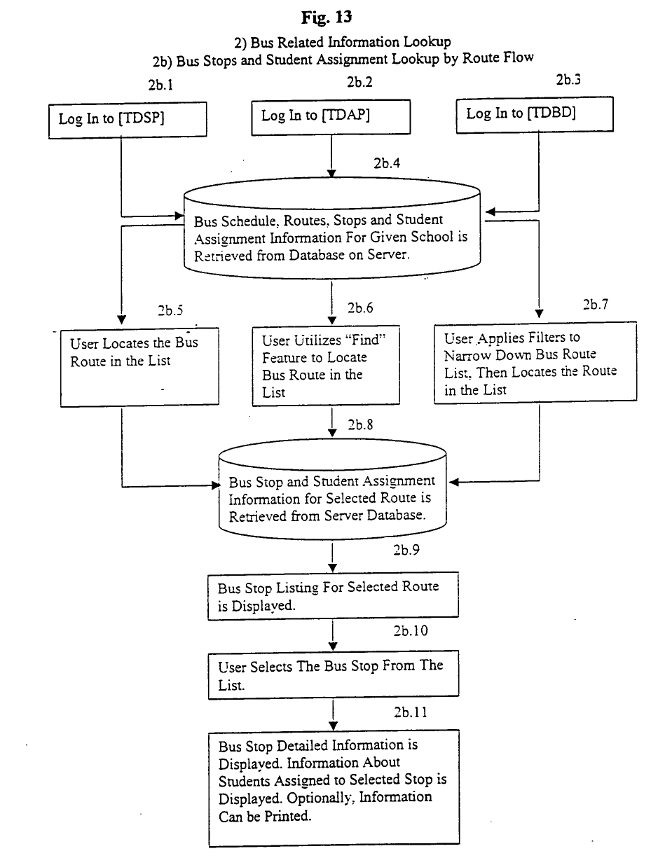

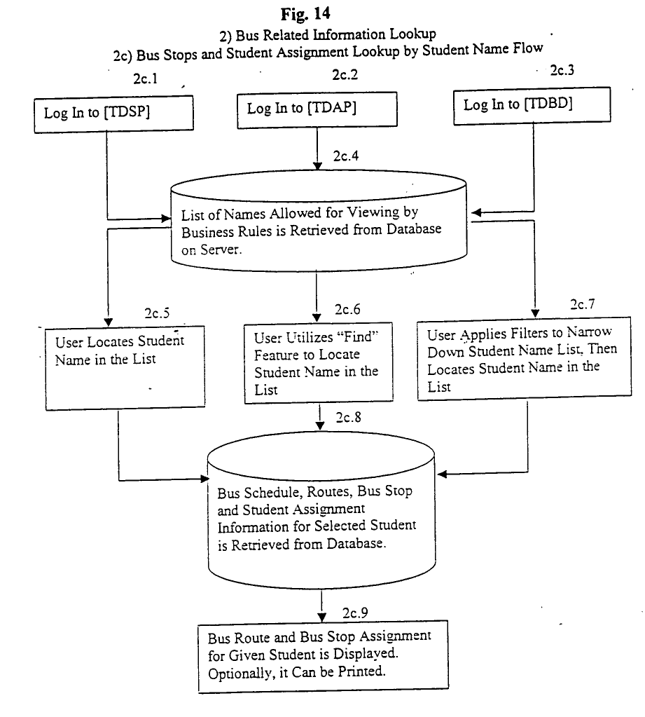

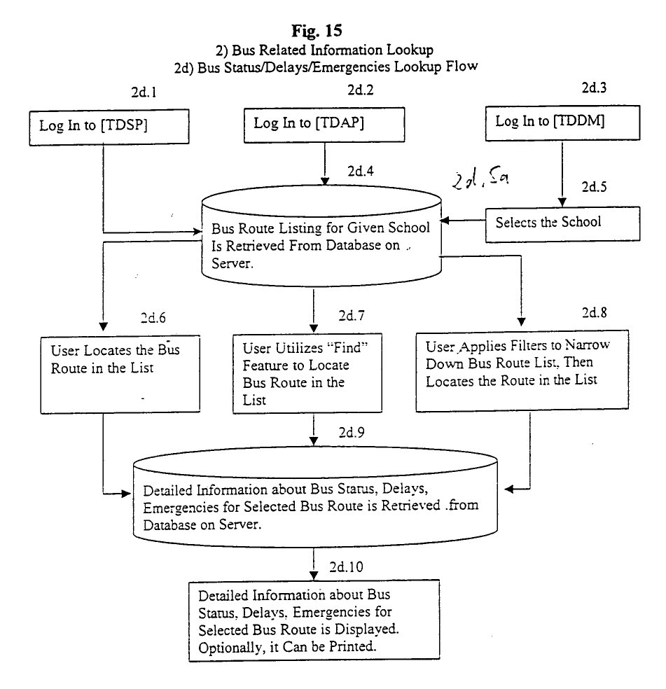

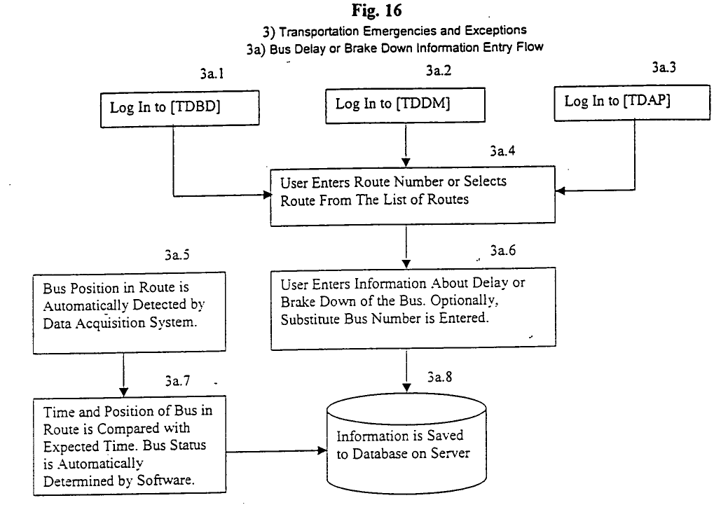

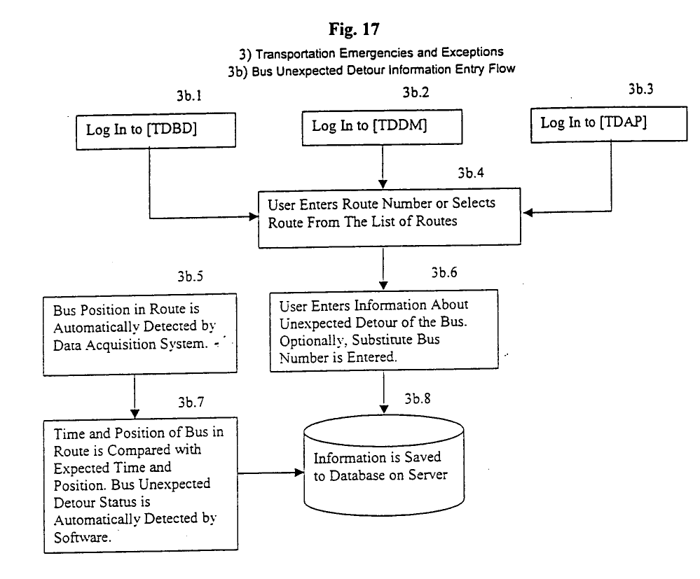

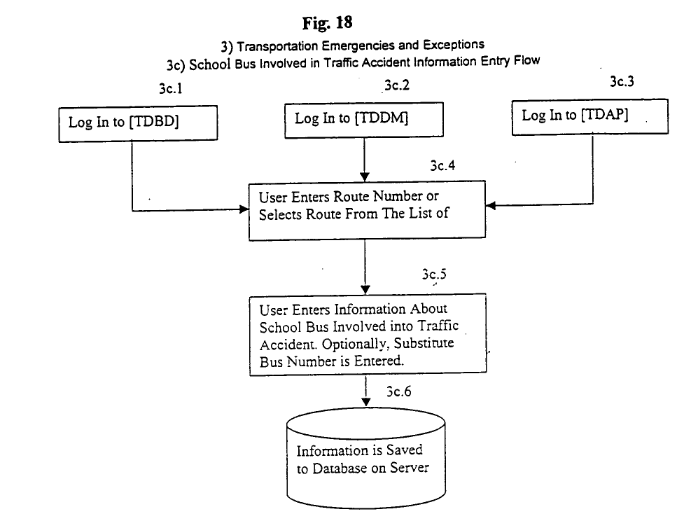

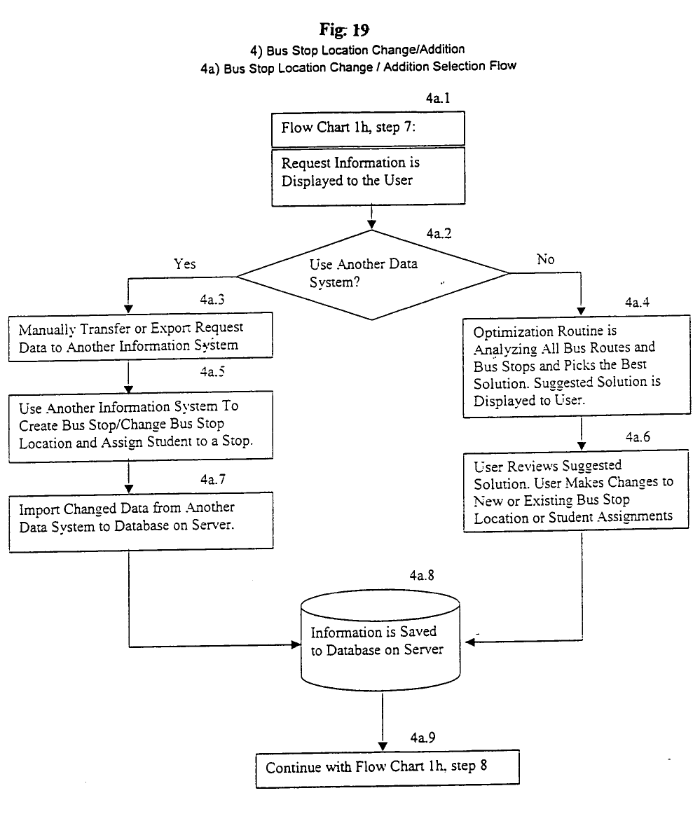

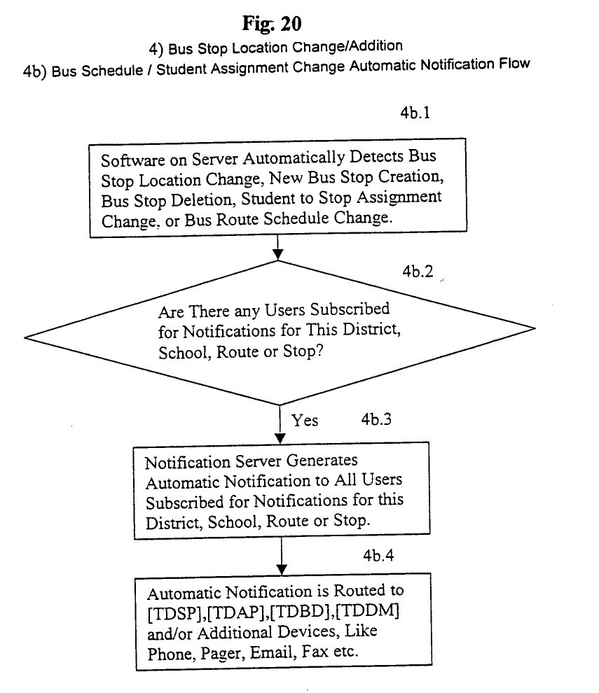

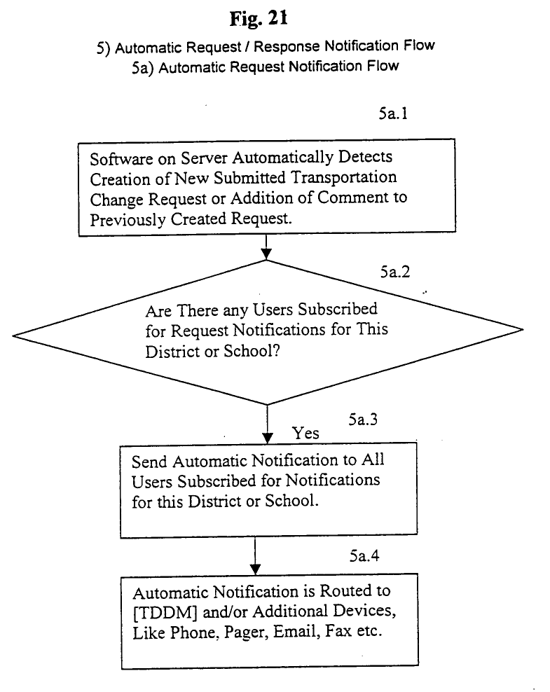

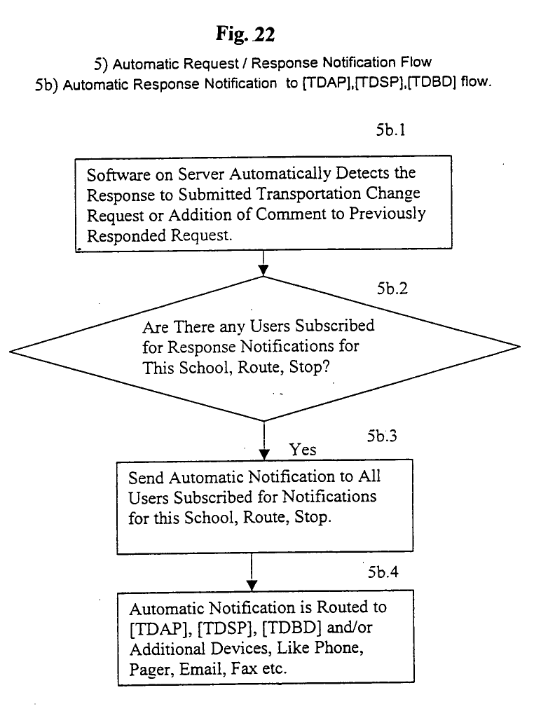

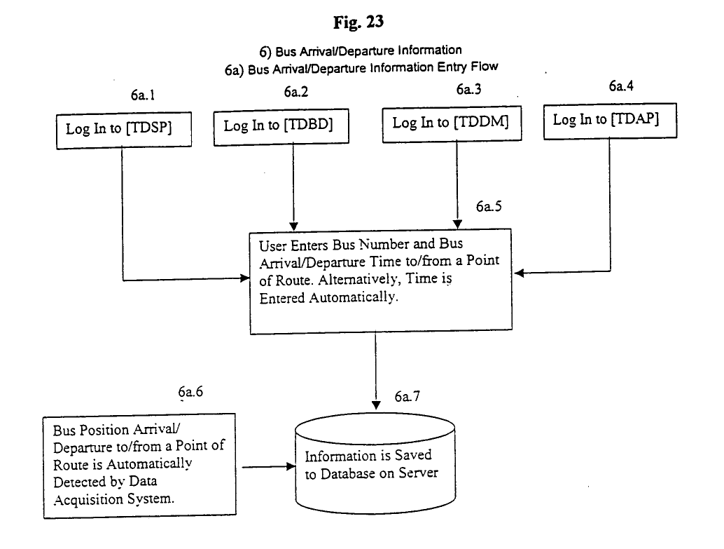

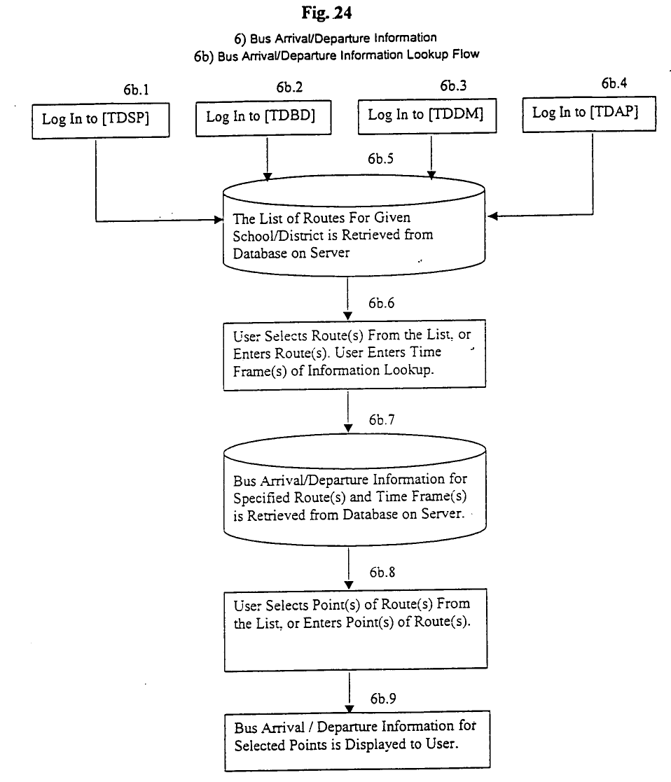

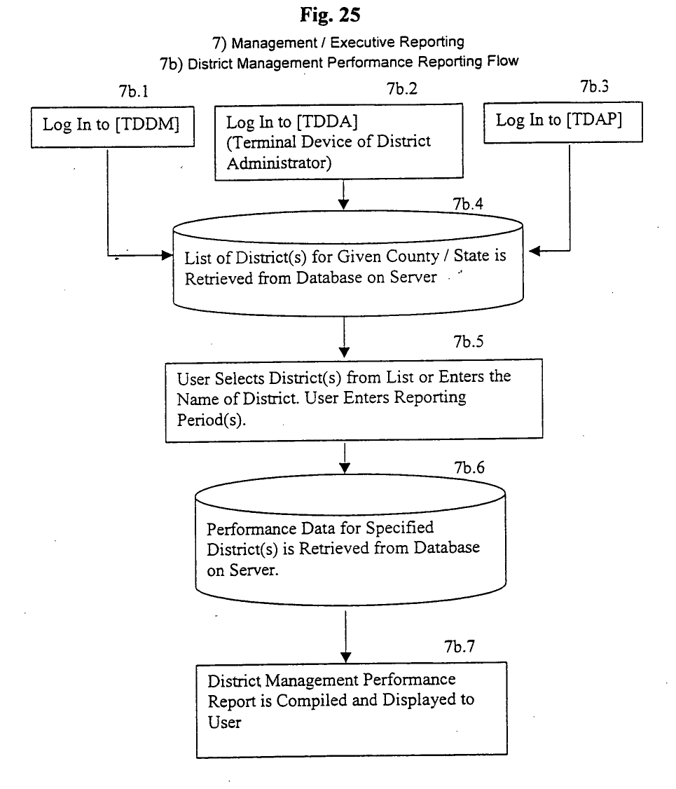

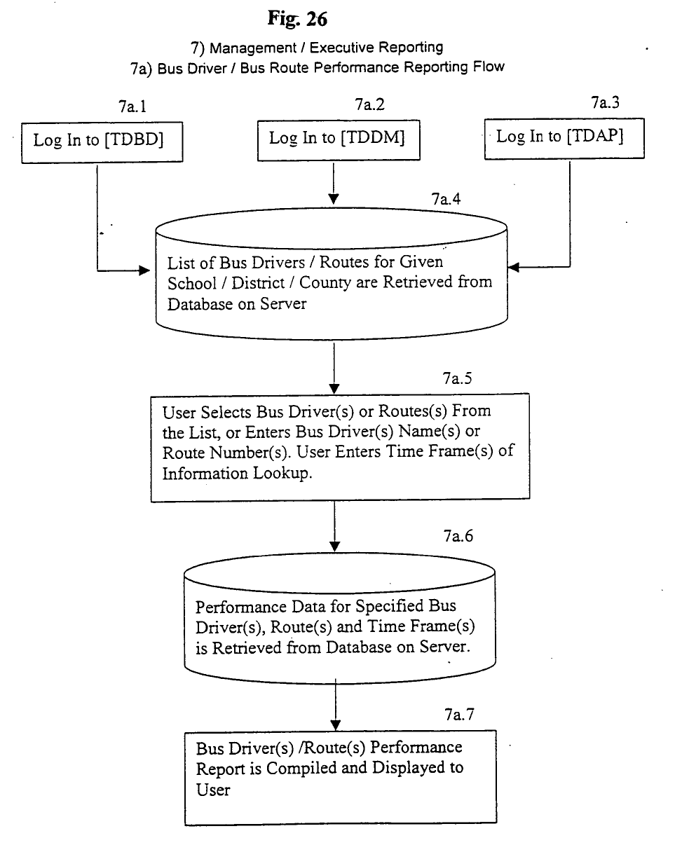

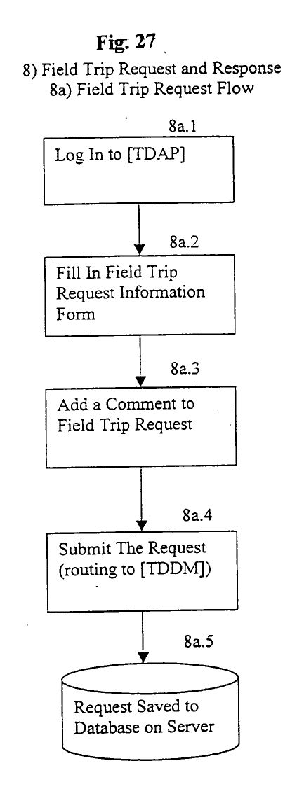

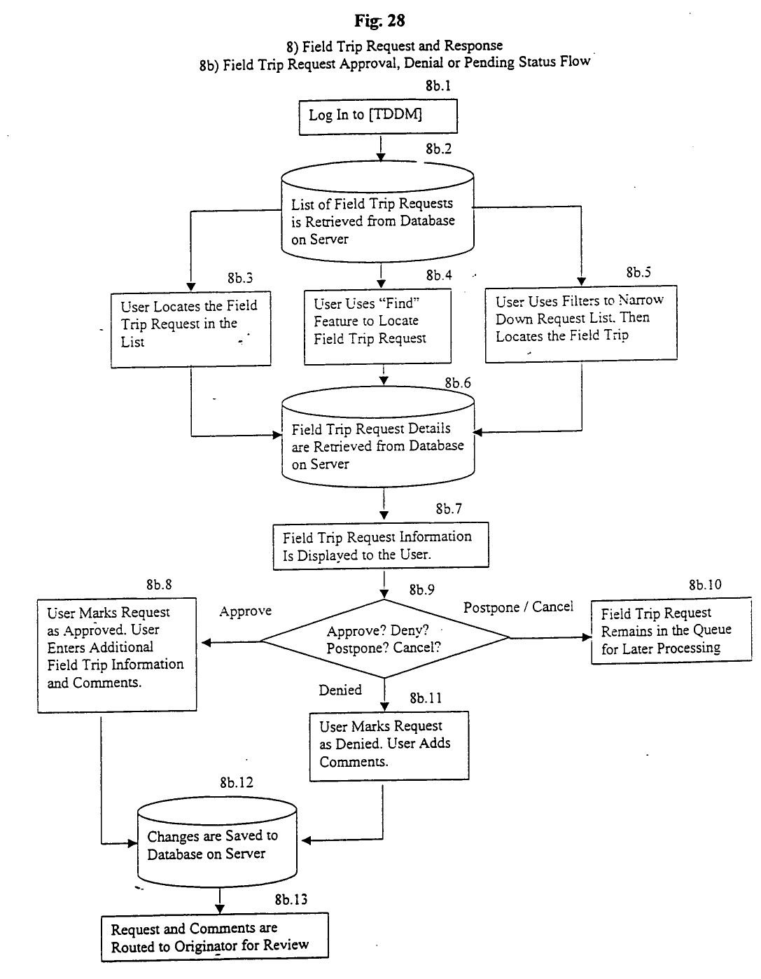

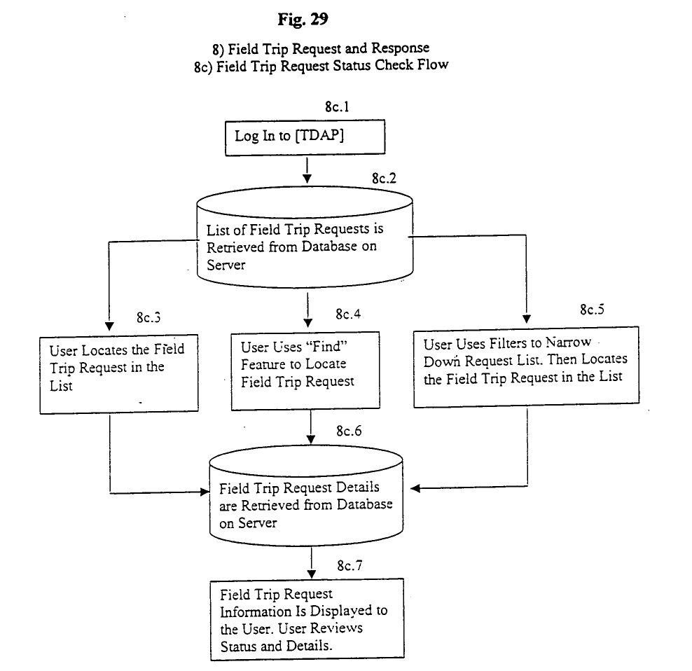

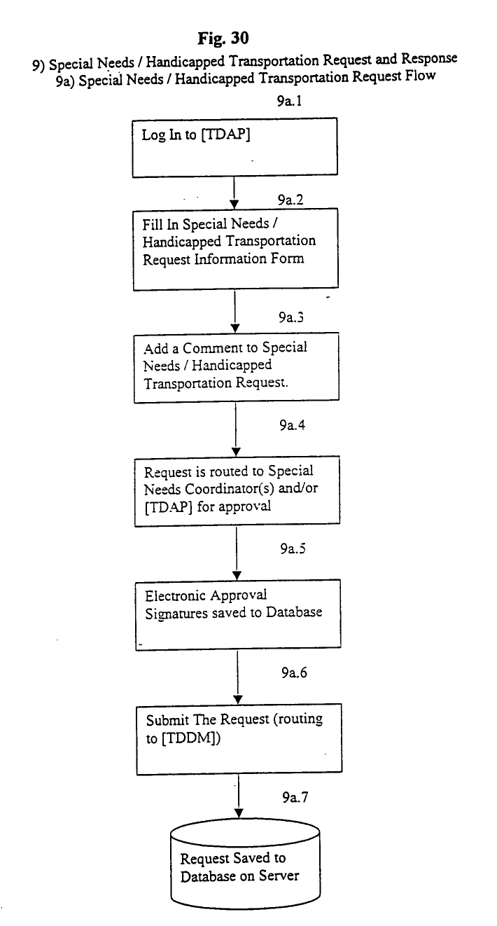

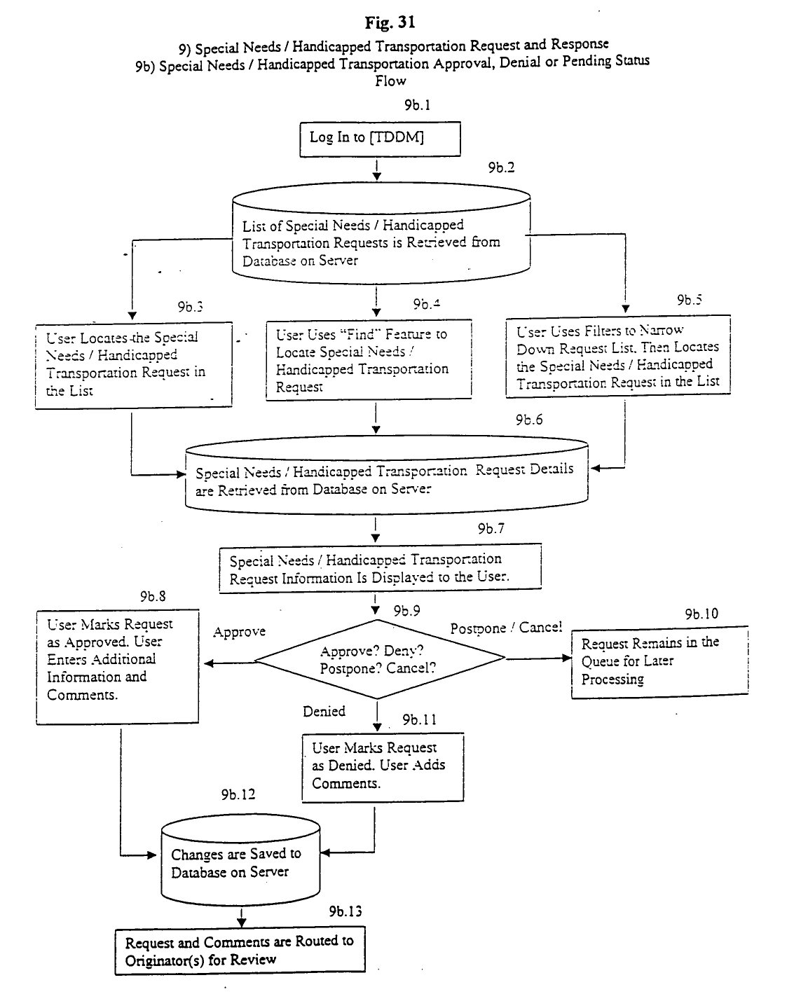

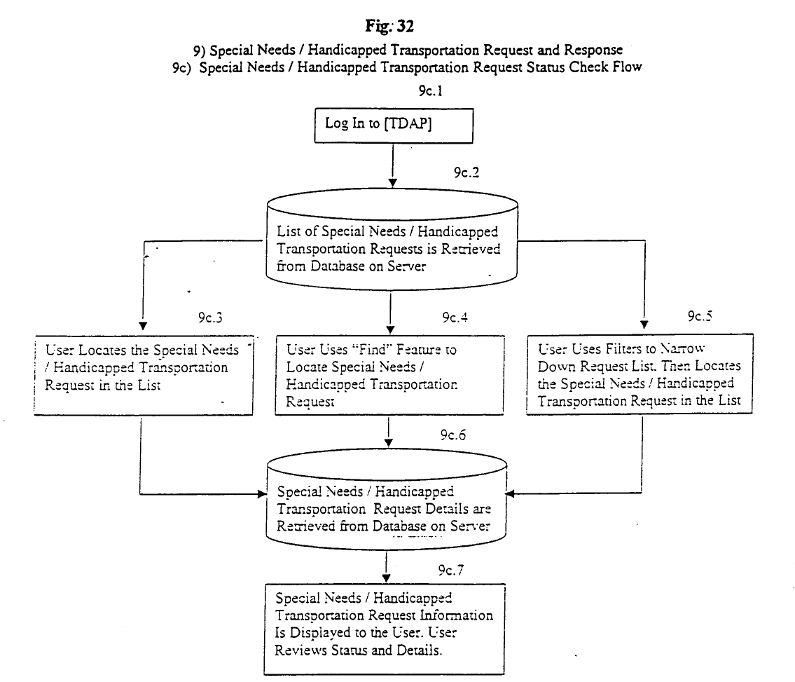

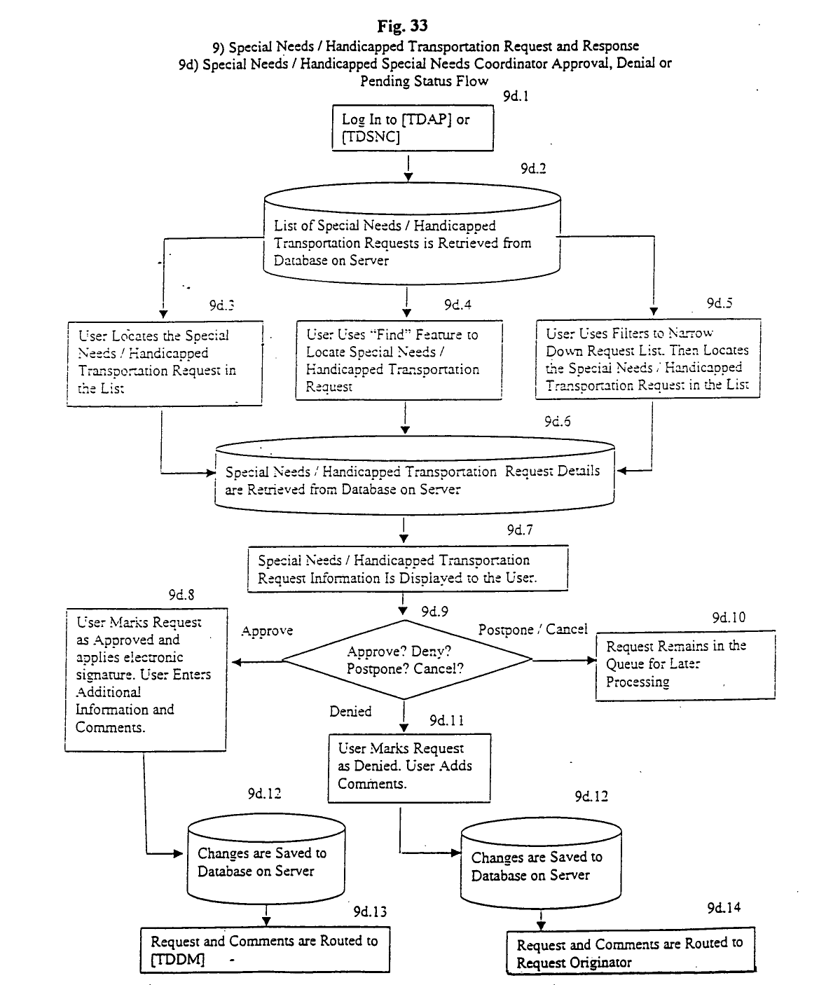

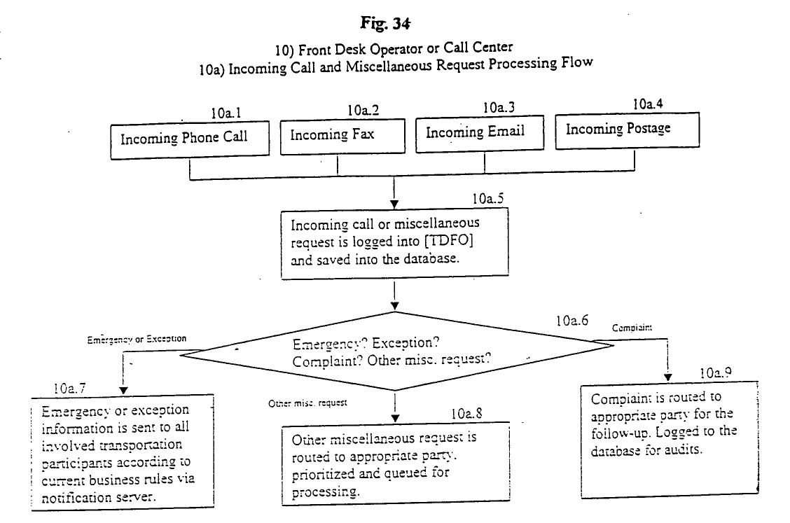

Transportation Change Request forms for new and for existing students according to some embodiments of the present invention are shown on FIGS. 3 and 4, respectively.

After the Transportation Request Change is submitted, some embodiments of the present invention provide for school transportation process participants to go back to the request to review status and contents, to make changes and/or to delete the request. The modification of request submitted earlier for the processing might be restricted by system's business rules. For example, the business rules might be configured to not allow any changes or cancellation of the request after it was submitted. It is understood that the specific set of business rules might vary between different system implementations.

Flowchart 1 f illustrates operations for retrieving a Transportation Change Request information to check the status and to review the information according to some embodiments of the present invention. After user logs in to one of the client's terminal devices (1f.1, 1f.2, 1f.3), the list of requests is retrieved from the database (1f.4). The business rules can control that only those requests are retrieved that current user has access to. Then one of several operations may be used to help user to identify the needed Transportation Change Request in the list (1f.5, 1f.6, 1f.7). After that the details of the request are retrieved from database (1f.8) and displayed to the user (1f.9). Optionally, the request can be printed or sent to any other output device connected to the network.

Flowchart 1g shows operations for changing or cancellation of existing Transportation Change Request according to some embodiments of the present invention. After the user logs in to one of the client terminal devices (1g.1, 1g.2, 1g.3), the list of requests is retrieved from the database (1g.4). The business rules can control that only those requests are retrieved that current user is entitled to work with. Then, one of several operations may be used to help user to identify the needed Transportation Change Request in the list (1g.5, 1g.6, 1g.7). After that the details of the request are retrieved from database (1g.8) and displayed to the user (1g.9). Currently implemented business rules may determine if the current request status allows the user to modify or cancel this request (1.g.11) at this point in time. If this is possible, then the user can change or even delete the request (1g.12, 1g.13), if not—user can only add a comment (1g.10) and save the request (1g.13). Information about history of all request changes also may be recorded into the database for audit purposes.

Transportation Change Requests are stored in the database, and, according to some embodiments of the present invention, all open requests may be organized into several queues for processing by different transportation officials of districts, counties and states (see Flowchart 1a, block 1a.7). Based on the request data and current business rules, operations may be performed to determine to which transportation official this request should be routed to, and specifies the priority of each request in the specific queue. The specific logic controlling this decision making process can change between embodiments of the present invention, and therefore it may be controlled by a flexible set of business rules, which can be adjusted. Each request in the queue is assigned to at least one of the processors. Alternatively, request originator can manually provide the processor information in time of request creation, if such action is allowed by the business rules.

Flowchart 1h illustrates operations for approval or denial of a Transportation Change Request according to some embodiments of the present invention. The transportation management official, for example a School District Manager, logs in to [TDDM] to process the requests queued by the system (1h.1). The queue information of requests allocated for this processor is retrieved from the database (1h.2). The user identifies the next request to process by one or more of three ways (1h.3, 1h.4, 1h.5). Request detailed information is retrieved from database (1h.6) and displayed to the user (1h.7). Then the processor goes through decision process represented by block (1h.8) in the flow chart, which is described in more details below and in the Flow Chart 4a. As a result of these operations, the processor can approve or deny the request, or the request can be postponed. The approved or denied request can be supplemented with comments (1h.9, 1h.10) and then it is saved to the server database (1h.12) and routed to the originator of the request (1h.1) for review. Postponed requests are returned to the queue and re-prioritized for processing at the later time. If business rules allow, the request can be manually or automatically transferred from one queue to another. For example, the user of [TDDM] at block (1h.8) can decide that a request should be transferred to the queue of another processor. In this case, the request is removed from the source queue, placed into the destination queue and re-prioritized in the destination queue.

Operations for appealing a denied transportation request according to some embodiments of the present invention are illustrated in Flowchart 1k. After user log in to one of the client's terminal devices (1k.1, 1k.2), the list of denied requests is retrieved from the database (1k.3). The business rules can control that only those requests are retrieved that current user has access to. Then one or more of several operations is used to help user to identify specific denied Transportation Change Request in the list (1k.4, 1k.5, 1k.6). After that the details of the request are retrieved from the database and displayed to the user (1k.7), and the Appeal Request is generated based on the denied Transportation Change Request (1k.8). The user can add the comments to the Appeal Request, and after that the request is saved into the database (1k.9) and routed for processing to [TDDM] or [TDDA]. The processes for request review, request changes or cancellations, request approval, denial or pending status, shown on Flowcharts 1f, 1g and 1h are also applicable to appeal requests.

2) Transportation Information Lookup and Reporting in Real Time

Some embodiments of the present invention can provide the School Children Transportation Process Participants with access and visibility to transportation information in real time. The availability of such information in real time can be provided since Transportation Change Requests and Bus Status, Emergencies, and Exceptions data are originated and handled by embodiments of the present invention. The changes in such data as school bus schedules, school bus routes and runs, school bus stop locations, school children assignments to bus stops may be captured according to some embodiments of the present invention at the time of Transportation Change Request processing, therefore that information can become available for various lookup routines in real time as well. Based on availability of this information, parents, school officials, transportation officials can for example make informed decisions about alternative ways of delivering children to destination points.

In this section only few examples of School Transportation information lookup according to some embodiments of the present invention are considered. However, according to other embodiments of the present invention, other information lookups may be provided. Although the lookup from only three types of client terminal devices is illustrated in the flowcharts 2a-2d, it is understood that other types of the client terminal devices can be used for this and other lookup processes, if the active business rules allow it.

After the information is retrieved by one or more of the embodiments described below and displayed to the user, this information can be sent to any peripheral device (like a printer), routed to another system user for further review, or sent as email transmission to any recipient.

One way of delivery of the retrieved information can be accomplished as a conversion of extracted data by a Text-to-Speech IVR feature into an audio output and transmission of the audio stream over the phone line to a participant of school transportation process, equipped with the telephone. IVR delivery can apply to any other information delivery according to some embodiments of the present invention.

In Flowchart 2a, School Bus Route and School Bus Schedule Lookup by the Bus Route is illustrated according to some embodiments of the present invention. After logging in to the terminal device (2a.1, 2a.2, 2a.3), the transportation information about school bus schedules, school bus routes and runs is retrieved from the database (2a.4). The retrieved information is indexed by bus route. The business rules can control that only the information permitted for viewing by a current user is retrieved. Using one or more of the available operations (2a.5, 2a.6, 2a.7), the user identifies the bus route(s) of interest. After that, more detailed information about this bus route is retrieved from the database (2a.8) and displayed to the user (2a.9).

In Flowchart 2b, operations for looking up and reporting the information about School Bus Stops and Student Assignment to Bus Stops by the Bus Route according to some embodiments of the present invention are illustrated. After logging in to the terminal device (2b.1, 2b.2, 2b.3), the transportation information about school bus stops and assignments of students to bus stops is retrieved from the database (2b.4). The retrieved information is indexed by bus route. The business rules control that only the information permitted for viewing by the current user is retrieved. Using one of the available operations (2b.5, 2b.6, 2b.7), the user identifies the bus route(s) of interest. After that more detailed information about this bus route(s) is retrieved from the database (2b.8) and the list of bus stops for the given route(s) is displayed to the user (2b.9). Then the user selects the specific bus stop(s) from the list by one of the available operations (2b.10) ). Detailed information about the selected stop is then displayed to the user (2b.11).

In Flowchart 2c, operations for looking up and reporting the information about School Bus Schedule, Routes, Stops and Student Assignment to Bus Stops by Student Name according to some embodiments of the present invention are illustrated. After logging in to the terminal device (2c.1, 2c.2, 2c.3), the listing of student names allowed for viewing by the business rules to current user is retrieved (2c.4). For example, if the user is a school official, only the names of students for the same school are retrieved. Using one of the available methods (2c.5, 2c.6, 2c.7), user identifies the student name(s) of interest. After that, more detailed information about the selected student(s) is retrieved from the database (2c.8) and the displayed to the user (2c.9).

In Flowchart 2d, operations for looking up and reporting the information about School Bus Status, Delays, and Emergencies by Bus Route is illustrated. After logging in to the terminal device (2d.1, 2d.2, 2d.3), the listing of bus routes allowed for viewing by the business rules to the current user is retrieved (2d.4). If the user (like District Manager) is permitted to see the routes of multiple schools, additional step of selecting the school prior to selecting the bus route might be used (2d.5). For example, if the user is a school official, only the bus routes servicing the same school may be retrieved. Using one or more of the available methods (2d.6, 2d.7, 2d.8), the user identifies the bus routes(s) of interest. After that, more detailed information about status, delays, emergencies related to selected routes(s) is retrieved from the database (2d.9) and displayed to the user (2d.10).

As it was already mentioned, a plurality of other similar information lookup operations is available according to some embodiments of the present invention.

3) Children Transportation Emergencies and Exceptions

Some embodiments of the present invention further include processing the information about School Bus Emergencies and Exceptions, which can streamline the handling of such situations for School Children Transportation Process Participants. The shortage of exact and timely information about exceptional situation with school children transportation can have a direct impact on safety of the involved school children, and lack of the information might be an obstacle to successful exceptions resolution. On the contrary, when timely and exact information about such exceptions is available to the transportation officials in the school, district, county and state, that information can be used for organized, quick and successful resolution of exceptions and emergencies.

In this section, only few examples of School Transportation Emergencies and Exceptions information handling are supplied. Other similar operations may be provided according to some embodiments of the present invention. Although the processing from only three types of client terminal devices is illustrated in the flowcharts 3a-3c, it is understood that other types of the client terminal devices can be used for this and other lookup processes, if the active business rules allow it.

Flowchart 3a shows operations for entering into the current system the Bus Delay or Break Down information. After log in to the client terminal device (3a.1, 3a.2, 3a.3), the user enters the route number of the school bus, or selects the route from the list of routes (3a.4). Then the user enters into the system the details about the delay or breakdown, such as delay reason, expected arrival time, breakdown type, breakdown location, etc. (3a.6). The information then is saved to the database (3a.8). In alternative embodiments, the position of the school bus at certain time moments and/or in certain route points may be automatically detected by one of the positioning systems, such as GPS or Bus Proximity sensors installed at some points of the bus route (3a.5). The data obtained from those data acquisition systems may be used to automatically compare the measured position of the school bus with the expected position of the bus according to the current schedule for the given route, and then the school bus status (delayed/in time/early arrival) may be determined automatically. Optionally, automatic notifications are sent to the selected Transportation Process Participants to inform them about bus delay or break down, and containing detailed information about the exception.

Flowchart 3b shows operations for entering Bus Unexpected Detour information according to some embodiments of the present invention. After log in to the client terminal device (3b.1, 3b.2, 3b.3), the user enters the route number of the school bus, or selects the route from the list of routes (3b.4). Then the user enters into the system the details about the bus unexpected detour, such as expected arrival time, detour location, etc. (3b.6). The information then is saved to the database (3b.8). In an alternative approach, the position of the school bus at certain time moments and/or in certain route points can be automatically detected by one of the positioning systems, such as GPS or Bus Proximity sensors installed at some points of the bus route (3b.5). The data obtained from those data acquisition systems is used to automatically detect the unexpected detour. Optionally, automatic notifications are sent to the selected Transportation Process Participants to inform them about bus unexpected detour, and containing the detailed information about the exception.

Flowchart 3c shows operations for entering into the current system the information about the School Bus involved in a traffic accident according to some embodiments of the present invention. After log in to the client terminal device (3c.1, 3c.2, 3c.3), the user enters the route number of the school bus, or selects the route from the list of routes (3c.4). Then the user enters into the system the details about the bus involved into the traffic accident, such as traffic accident location, time, severity, medical emergency request, fire emergency request etc. (3c.5). The information is then saved to the database (3c.6). Optionally, automatic notifications are sent to the selected Transportation Process Participants to inform them about bus unexpected detour, and containing the detailed information about the exception.

4) Bus Stop Location Change/Addition

The processing of Transportation Change Request was illustrated on flowchart 1h. When a Transportation Change Request is processed by district, county or state transportation officials, such complex decisions as creation of new bus route, bus run or bus stop, changing the location of the existing bus stop, assignment of the school child to one of the bus stops, should be made in a very limited time frame. The cost of the mistake while making these decisions might be very high, since children safety may be on the line. To enable productive and precise processing of Transportation Change Requests, embodiments of the invention can provide computerized decision support tools.

Embodiments of the invention can provide Transportation Change Request processing using native features and/or allowing the utilization of external software tools and systems available from third party vendors.

During the start-up of some embodiments of the present invention, the routes and runs may be initially populated in the system. This can be done by one or more of the following and/or other ways:
bus routes, runs and stops are created using native operations of the current system.
bus routes, runs and stops are initially created in one or more external information system, and than are imported into embodiments of the invention using, for example, an import procedure designed to read the data from the external application, validate data integrity and safely load the data from the external application into a database of embodiments of the invention.

In the first scenario, the list of students in need of transportation is loaded from an external database and/or entered manually. That initial student list might include student names, identification numbers, school information, pickup and delivery address for each student, and/or other student transportation data. Based on that list, some embodiments of the invention can generate the routes, runs and stops automatically using an optimization routine, described in more detail below. Routes, runs and/or stops may be generated automatically, and after that they may be reviewed, modified and saved onto the database by the authorized users.

In the Flowchart 4a, processing of the School Transportation Change Request by a Transportation Official for District, County, or State is illustrated. The initial operations of the request processing were described earlier and illustrated on Flowchart 1h. After review of the Transportation Change Request (4a.1), the user can utilize external information system to make the decisions about the requested change and/or utilize the native methods of the current system (4a.2). In the first case, the request information is manually transferred or exported out of the current system into the other system (4a.3), where the decisions about bus routes and runs, bus stops and student assignments are made (4a.5), and after that the changes are imported back into the current system (4a.7) and saved in the database (4a.8). In the second case, the information from the Transportation Change Request is used by the optimization routine, which analyzes bus routes and bus stops for the given school, and attempts to find the optimum solution about satisfying the current request while minimizing both route duration and/or route distance (4a.4). In some embodiments, one or more of the following factors and/or others are used by the optimizer with different weights:
Safety, minimum possible amount of roads to be crossed by a child,
Proximity, minimum distance between the child's pick-up or drop off location and the bus stop,
Minimum distance and duration of bus routes,
Run duration, minimum amount of stops for each bus run,
Optionally, specific requirements mentioned in the request.

When the solution is generated by the optimization routine, the user reviews it (4a.6) and makes changes to the solution if necessary. The user can also adjust the input parameters of optimization and re-run the optimization. When the user confirms the solution, the information about new students, new/changed bus stop locations, bus schedules, bus routes and runs, and the assignment of the student to the bus stop is updated in the database (4a.8). After that, operations continue as described in Flowchart 1h, step 1h.8.

Flowchart 4b illustrates automatic notification generation on Notification Server after the changes to the school bus schedules, routes, runs, bus stop locations and assignments of students to bus stops during the processing of Transportation Change Request are made, according to some embodiments of the present invention. Prior to saving these changes to the database, the software compares the data to save to the data in the database. If the software on the server detects that a change has occurred (4b.1), the subscription listing is checked and the list of information recipients subscribed to notifications about this specific district, school, route, bus stop, student etc. is compiled. If the subscriber list is not empty (4b.2), notifications are generated and sent to all subscribed users (4b.3, 4b.4). The operations can eliminate or reduce the need in time-consuming, costly and/or unreliable manual notifications, which are widely used in today's school transportation management.

5) Automatic Request/Response Notification Flow

Automatic notifications are designed to provide timely information to participants of School Children Transportation Process. Several examples of automatic notifications according to some embodiments of the present invention will be described.

Flowchart 5a illustrates automatic notification generation on submission of new Transportation Change Request according to some embodiments of the present invention. The software on the server detects the submission of new Transportation Change request (5a.1). The software compiles the list of recipients subscribed for notification for this event and this school/district/county (5a.2). If the list is not empty (5a.2), the Notification server generates and sends automatic notifications to the client terminal devices of users in the list (5a.3, 5a.4) according to their subscription.

Flowchart 5b details operations of notification generation on processing, modification or addition of comment to the Transportation Change Request according to some embodiments of the present invention. The software on the server detects one of the above events (5b.1). The software compiles the list of recipients subscribed for notification for this event and this school/district/county (5b.2). If the list is not empty (5b.2), the Notification server generates and sends automatic notifications to the client terminal devices of users in the list (5b.3, 5b.4) according to their subscription.

Other embodiments can provide user notification for such system events as Appeal Request submission and processing, Special Needs/Handicapped Request submission and processing, Field Trip request submission and processing, Transportation Exception or Emergency filing, Bus Arrival/Departure filing and many others. Operations can be similar to those which were described above.

6) Bus Arrival/Departure Information

Operations may be provided, according to some embodiments of the present invention, for Bus Arrival and Departure information handling. Bus Arrival and Departure data can provide information to participants of the system about the performance of bus drivers and/or reasons of latencies. This information can allow transportation managers to identify and address problems early on. The information about arrivals and departures of buses can be immediately available on the server to participants of the system. Software can collect this data, analyze it and route the results of analysis to traffic managers, giving them information enabling them to take corrective actions to resolve the problem. In contrast, conventionally, an AP manually records arrival and departure time using pen and paper. At the end of the week this information is faxed over to the Transportation Office, where information received from all the schools is in the best case manually analyzed, which can be a very tedious and inefficient process.

Flowchart 6a illustrates operations for collecting the data about Bus Arrival and Departure according to some embodiments of the present invention. After logging in to one of terminal devices (6a.1, 6a.2, 6a.3, 6a.4), the user enters the bus route number and/or selects it from the list (6a.5). The time of the arrival/departure is entered manually or derived from the system clock of the client terminal or the server (6a.6). The user can adjust the information and save it to the database (6a.7). In an alternative approach, the arrival/departure of the school bus at certain time moments and/or in certain route points may be automatically detected by one of the positioning systems, such as GPS and/or Bus Proximity sensors installed at some points of the bus route (6a.6). The data obtained from those data acquisition systems may be used to automatically log the arrival/departure times.

In Flowchart 6b, operations for School Bus Arrival/Departure information lookup according to some embodiments of the present invention are shown. After user login to one of the client terminal devices (6b.1, 6b.2, 6b.3, 6b.4), the list of school bus routes is retrieved, available to the given user for review by the business rules (6b.5). The user enters the route(s) and/or selects the route(s) from the list by one of the available methods. In addition, the user can narrow down the time frame of the request by specifying the beginning and the end of the lookup period (6b.6). The information is retrieved from database (6b.7) and the list of points on the selected route(s) is compiled in which school bus arrival or departure information is available for given route(s) (6b.8). The user selects the point(s) of interest, and the information about school bus arrivals to and departures from these points is presented to the user for review and reporting.

7) Management Reporting

The information stored on the server can be utilized for management reports, assisting the transportation officials in management of School Children Transportation process. Two examples of management reports according to some embodiments of the present invention are described below.

In Flowchart 7a, Bus Driver and Bus Route Performance Management Reporting according to some embodiments of the present invention is shown. After user log in to one of the client terminal devices (7a.1, 7a.2, 7a.3), the list of Bus Drivers and Bus Routes for given school, district, county or state is retrieved from the database (7a.4). The business rules can control that the information allowed to given user for review is retrieved. The user enters or selects one or more bus driver(s) or bus route(s) from the list, enters the time frames of reporting period (7a.5). Performance data for specified bus driver(s) or bus route(s) are retrieved from the database (7a.6), a report is compiled and presented to the user for review (7a.7). Optionally, the report can be routed to any other participant, or sent to a peripheral device, like a printer.

In Flowchart 7b, the District Performance Management Reporting according to some embodiments of the present invention is shown. After user log in to one of the client terminal devices (7b.1, 7b.2, 7b.3), the list of Districts for given county or state is retrieved from the database (7b.4). The business rules control that only the information allowed to given user for review is retrieved. The user enters or selects one or more districts(s) from the list, enters the time frames of reporting period (7b.5). Performance data for specified district(s) are retrieved from the database (7b.6), report is compiled and presented to the user for review (7b.7). Optionally, report can be routed to any other participant, or it can be sent to any peripheral device, like a printer or fax.

8) Field Trips Request

Some embodiments of the invention can provide operations to allow school transportation officials to send a Field Trip Request, to check the status of the request and to send an appeal request in case the request is denied. As in case with Transportation Change Requests, district, county or state transportation managers can process Field Trip requests.

Flowchart 8a shows operations for Field Trip Request Creation according to some embodiments of the present invention. The process is originated with logging in of one of school children transportation process participants to their client terminal device (8a.1). Although only [TDAP] is shown on the flowchart, the Field Trip Request can be originated from the device of any participant of school children transportation process, according to some embodiments of the present invention, as long as it is allowed by business rules. After the Field Trip Request form is filled (8a.2), the comment(s) with additional information can be attached to the request (8a.3), then request is saved and submitted to the transportation official of district, county or state (8a.4, 8a.5).

All Field Trip Requests are stored in the database and, according to some embodiments of the present invention, open requests are organized into the queues for processing by transportation officials of districts, counties and states (see Flowchart 1a, block 1a.7). Based on the request data and current business rules the system derives to which transportation official this request should be routed to, and specifies the priority of each request in the specific queue.

Flowchart 8b illustrates operations for approval or denial of Field Trip Requests, according to some embodiments of the present invention. The transportation management official, for example a School District Manager, logs in to [TDDM] to process the requests queued by the system (8b.1). The queue information of Field Trip Requests allocated for this processor is retrieved from the database (8b.2). The user identifies the next request to process by one or more of three ways (8b.3, 8b.4, 8b.5). Field Trip Request detailed information is retrieved from the database (8b.6) and displayed to the user (8b.7). Then the processor makes a decision on the Field Trip Request (8b.9). The approved or denied request supplemented with comments (8b.8, 8b.11) is saved to the server database (8b.12) and routed to the originator of the request (8b.13) for review. Postponed requests are returned to the queue and re-prioritized for processing at the later time. Also, if business rules allow, the Field Trip request can be manually or automatically transferred from one queue to another.

Flowchart 8c illustrates operations for retrieving the Field Trip Request information to check the status and to review the information according to some embodiments of the present invention. After user log in to one of the client's terminal devices (8c.1), the list of requests is retrieved from the database (8c.2). The business rules control that only those Field Trip requests are retrieved that current user has access to. Then one or more of several techniques is used to help user to identify the needed Field Trip Request in the list (8c.3, 8c.4, 8c.5). After that the details of the Field Trip request is retrieved from database (8c.6) and displayed to the user (8c.7). Optionally, the request can be printed or sent to any other output device connected to the network.

Other embodiments of the present invention can also provide operations for modifying, canceling the active Field Trip Request, and for filing Field Trip Appeal Request.

9) Special Needs/Handicapped

Some embodiments of the present invention can provide communications to allow school transportation officials to send a Special Needs/Handicapped Request, to check the status of the request and to send an appeal request in case the request is denied. As in case with Field Trip Requests, district, county or state transportation manager processes Special Needs/Handicapped Requests.

Flowchart 9a shows operations for Special Needs/Handicapped Request Creation according to some embodiments of the present invention. Operations begin with logging in of one of school children transportation process participants to their client terminal device (9a.1). Although only [TDAP] is shown on the flowchart, the Special Needs/ Handicapped Request can be originated from the device of any participant of school children transportation process, as long as it is allowed by business rules. After the Special Needs/Handicapped Request form is filled (9a.2), the comment(s) with additional information can be attached to the request (9a.3). At this point, the request may require special approval from varying officials depending on the administrative rules of the school, county or state. If approval is required, the request is routed to the terminal devices of the persons who are authorized to give approval. (9a.4) Based on the login and password authentication, electronic signatures are then applied to the request by the persons authorized to approve special needs requests and these signatures are stored in the database with the request. (9a.5) The request is then saved and submitted to the transportation official of district, county or state (9a.6, 9a.7).

Special Needs/Handicapped Requests are stored in the database, and some embodiments of the present invention organize all open requests into the queues for processing by transportation officials of districts, counties and states (see Flowchart 1a, block 1a.7). Based on the request data and current business rules the system derives to which transportation official this request should be routed to, and specifies the priority of each request in the specific queue.

Flowchart 9b illustrates operations approval or denial of Special Needs/Handicapped Request according to some embodiments of the present invention. The transportation management official, for example a School District Manager, logs in to [TDDM] to process the requests queued by the system (9b.1). The queue information of Special Needs/Handicapped Requests allocated for this processor is retrieved from the database (9b.2). The user identifies the next request to process by one of three ways (9b.3, 9b.4, 9b.5). Special Needs/Handicapped Request detailed information is retrieved from database (9b.6) and displayed to the user (9b.7). Then the processor makes a decision on the Special Needs/Handicapped Request (9b.9). The approved or denied request supplemented with comments (9b.8, 9b.11) is saved to the server database (9b.12) and routed to the originator of the request (9b.13) for review. Postponed requests are returned to the queue and re-prioritized for processing at the later time. Also, if business rules allow, the Special Needs/Handicapped request can be manually or automatically transferred from one queue to another.

Flowchart 9c illustrates operations for retrieving the Special Needs/Handicapped Request information to check the status and to review the information according to some embodiments of the present invention. After user log in to one of the client's terminal devices (9c.1), the list of requests is retrieved from the database (9c.2). The business rules control that only those Special Needs/Handicapped requests are retrieved that current user has access to. Then one or more of several techniques is used to help user to identify the needed Special Needs/Handicapped Request in the list (9c.3, 9c.4, 9c.5). After that the details of the Special Needs/Handicapped request is retrieved from database (9c.6) and displayed to the user (9c.7). Optionally, the request can be printed or sent to any other output device connected to the network.

Flowchart 9d illustrates operations for approval or denial of Special Needs/Handicapped Request by the Special Needs Coordinator or any other official whose approval is outside of the normal request process flow according to some embodiments of the present invention. The transportation management official, for example a School Assistant Principal or Special Needs Coordinator, logs in to [TDAP] to process the requests queued by the system (9d.1). The queue information of Special Needs/Handicapped Requests allocated for this processor is retrieved from the database (9d.2). The user identifies the next request to process by one or more of three ways (9d.3, 9d.4, 9d.5). Special Needs/Handicapped Request detailed information is retrieved from database (9d.6) and displayed to the user (9d.7). Then the processor makes a decision on the Special Needs/Handicapped Request (9d.9). The approved or denied request supplemented with comments (9d.8, 9d.11) is saved to the server database (9d.12) with an electronic signature if approved (9d.8). If the request is approved it is routed to the District Manager [TDDM] (9d.13). If the request is denied it is routed to the originator of the request (9b.14) for review. Postponed requests are returned to the queue and re-prioritized for processing at the later time. Also, if business rules allow, the Special Needs/Handicapped request can be manually or automatically transferred from one queue to another.

Other embodiments of the present invention also provide for modifying, canceling the active Special Needs/Handicapped Request, and for filing Special Needs/Handicapped Appeal Request.

10) Front Desk Operator/Call Center Incoming Request Flow.

Some embodiments of present invention further include ability to process incoming miscellaneous requests, from various sources. Miscellaneous requests include but are not limited to requests from parents to inquire about the status of a transportation change request, requests from a DM to inquire about the status of a bus in the maintenance facility, requests from parents or Assistant Principals to inquire about the location of a bus that has not arrived at a particular stop within a reasonable amount of time, and transportation change requests themselves. Entering these miscellaneous requests into the system can streamline the work of the Front Desk or Call Center Operator, and can provide better control and visibility of the incoming miscellaneous requests, and reduces the chances of possible request information losses.

In Flowchart 10a, the additional system component called Terminal Device of Front Desk or Call Center Operator [TDFO] is introduced. Transportation Office Front Desk or Call Center (10a.1, 10a.2, 10a.3, and 10a.4) can constantly receive miscellaneous requests in the form of phone calls, faxes, email and postal correspondence. The operator determines request type and logs the details of the request into the [TDFO] (10a.5). Depending upon incoming request type, the business rules for request processing might vary. Some embodiments of the present invention can route logged requests according to currently defined business rules (10a.6). If the request is qualified as an emergency (10a.7), the notification server can immediately route the emergency information to parties designated to handle emergencies according to current business rules and request details. Some embodiments of the present invention might include automatic request escalation if an active emergency request is not acknowledged during the defined time window, thus providing a higher assurance of request acknowledgement. Complaints and other miscellaneous requests also may be logged into the database to provide information for subsequent follow-up actions and audits (10a.8), (10a.9).

11) Database Description

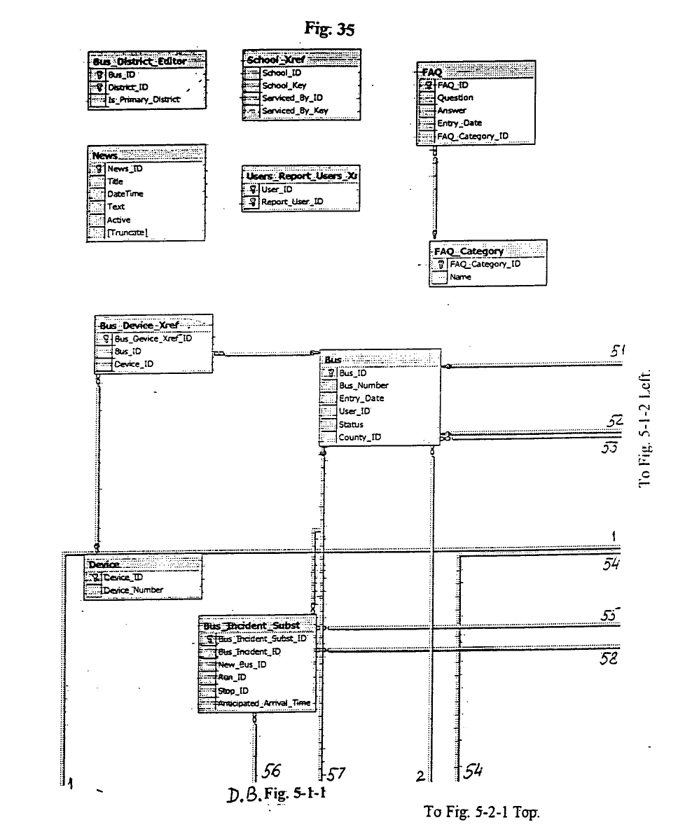

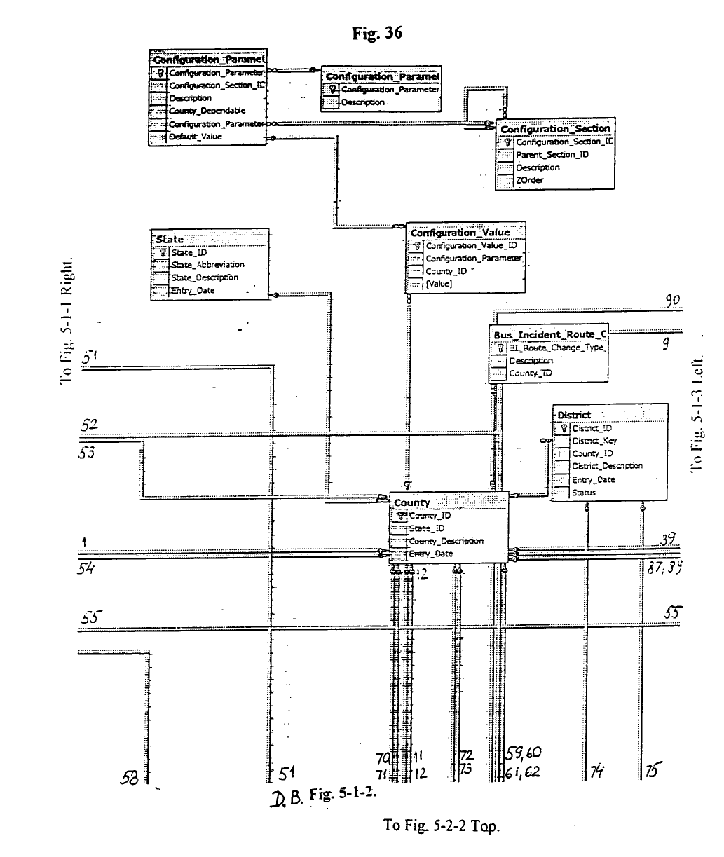

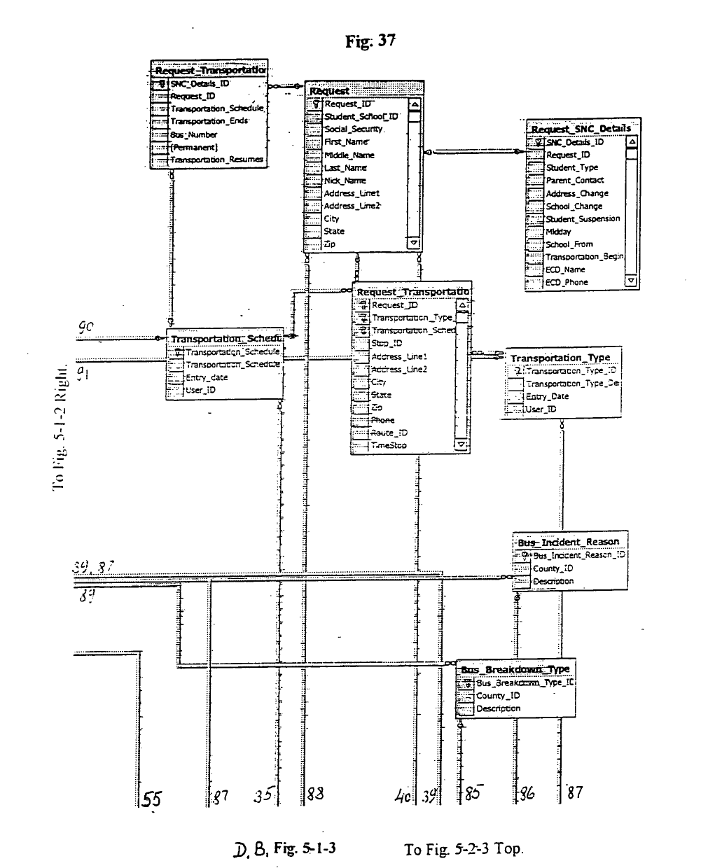

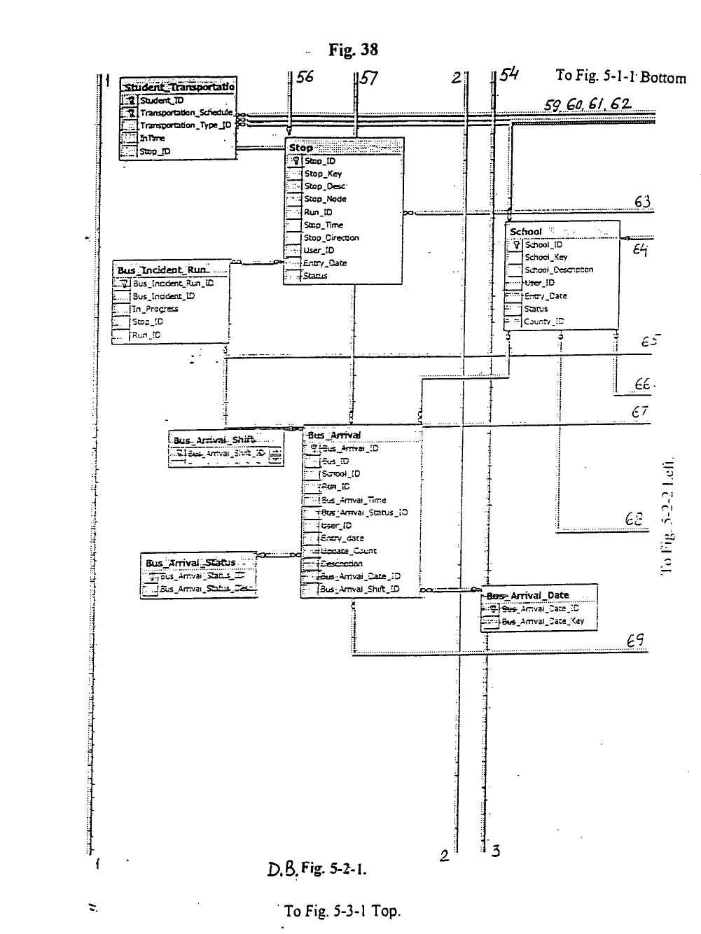

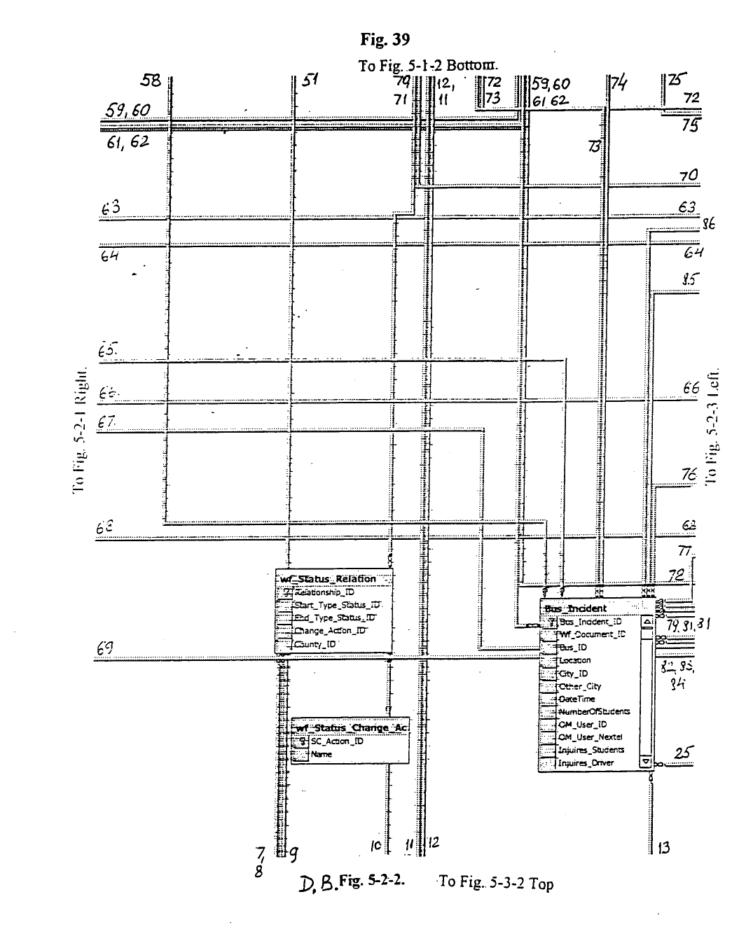

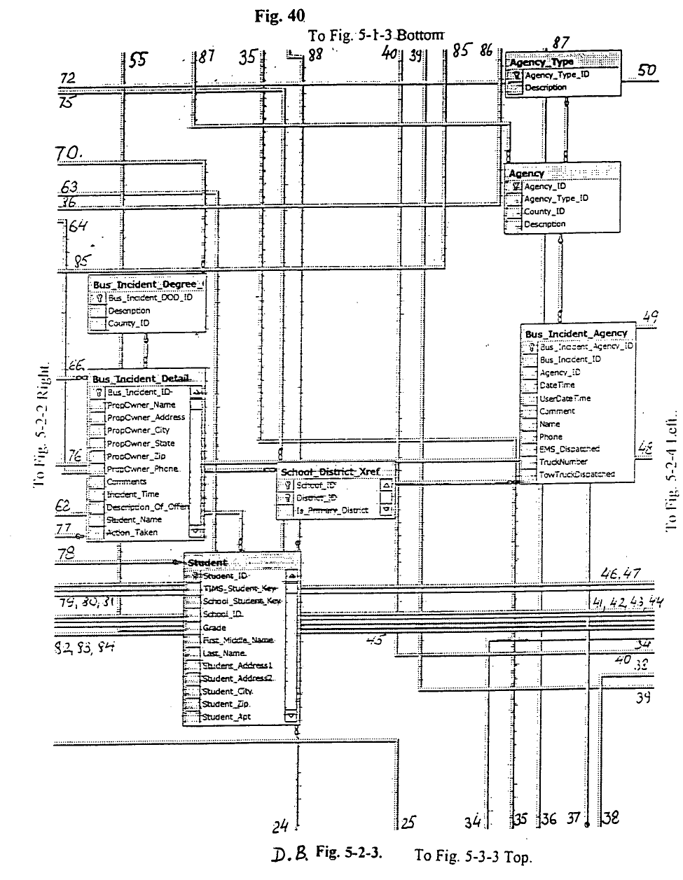

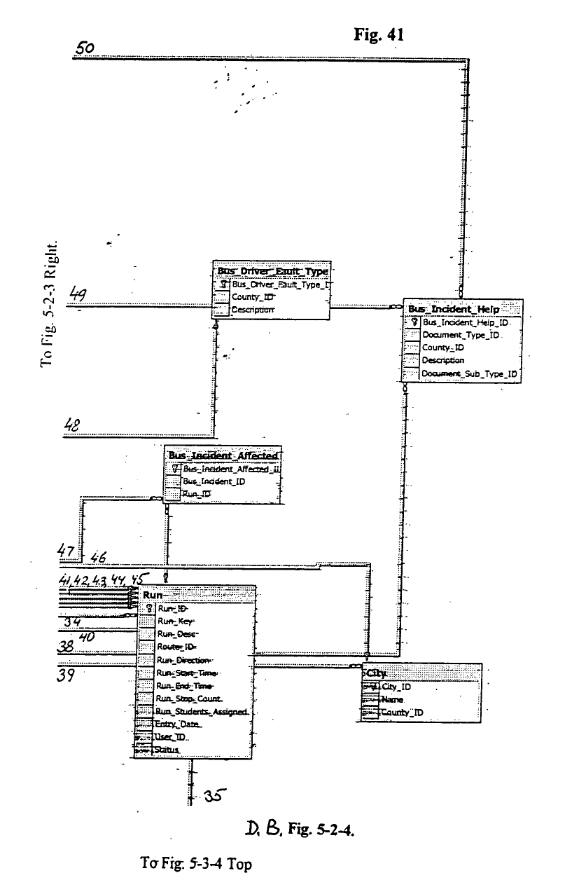

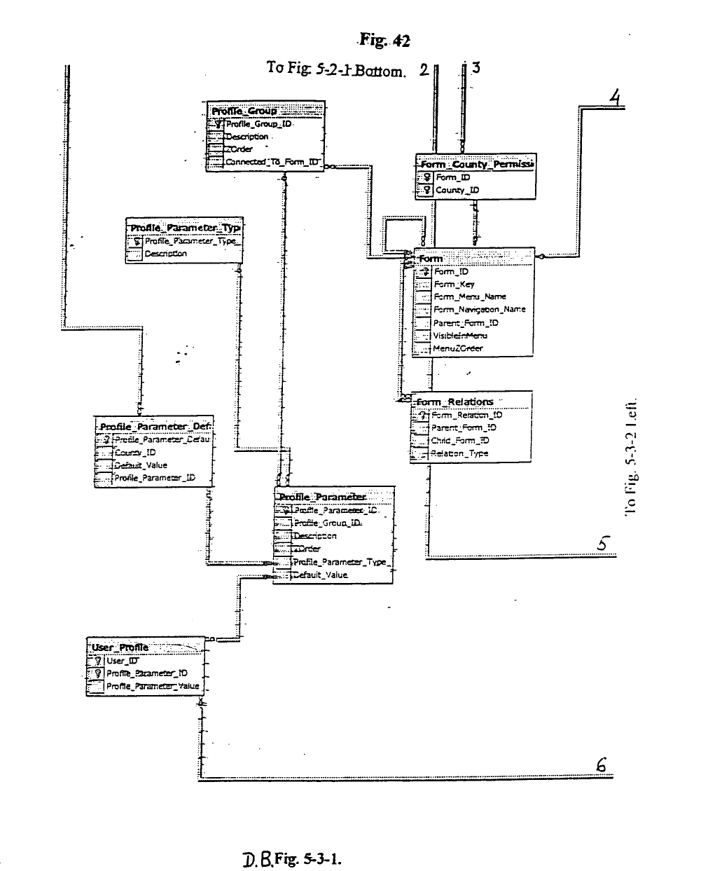

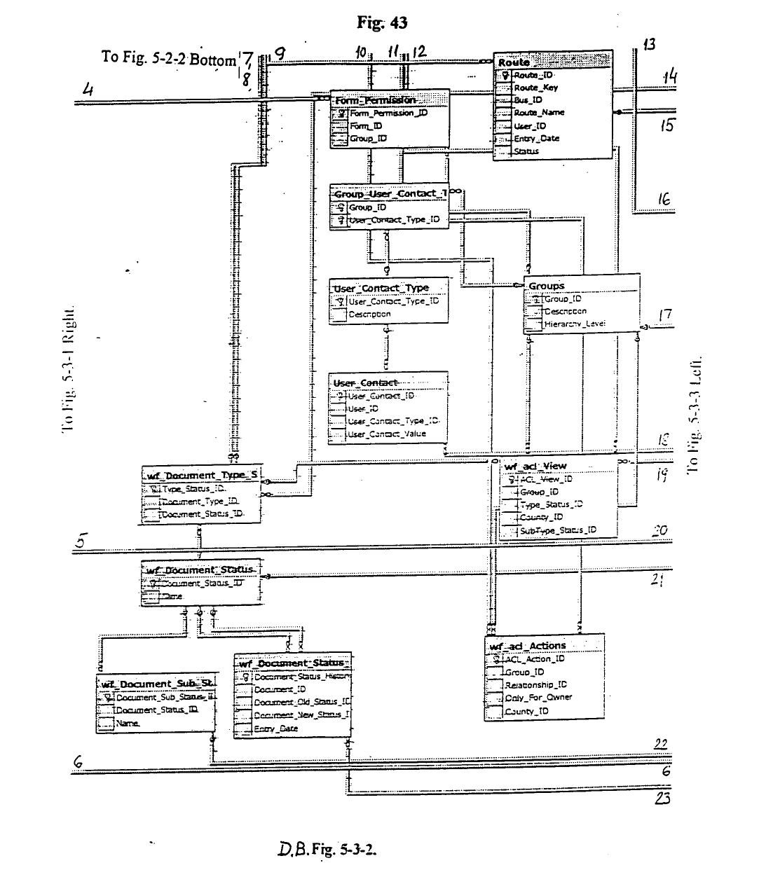

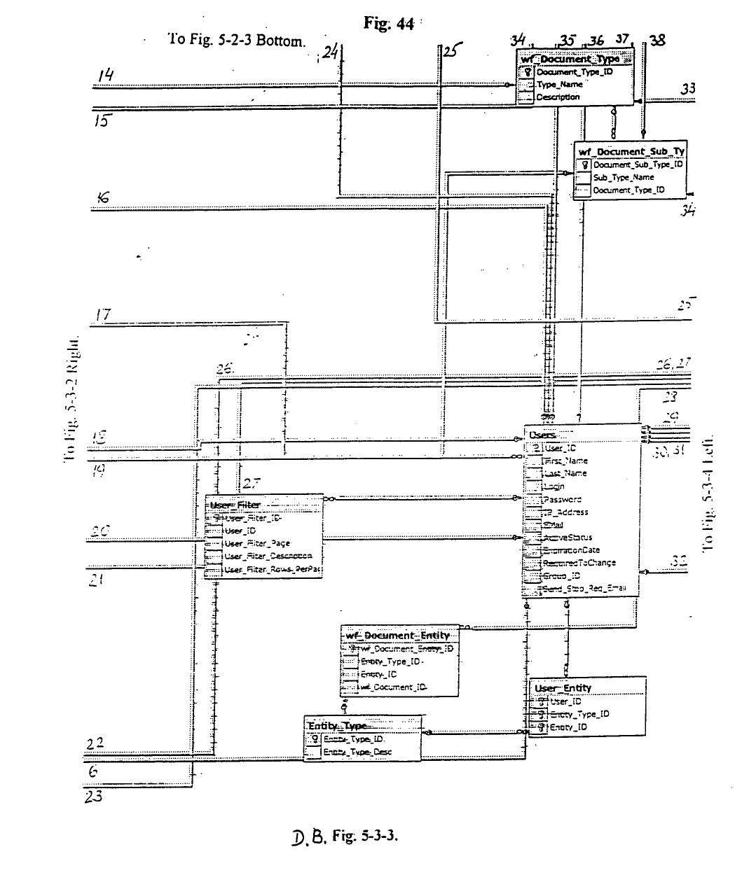

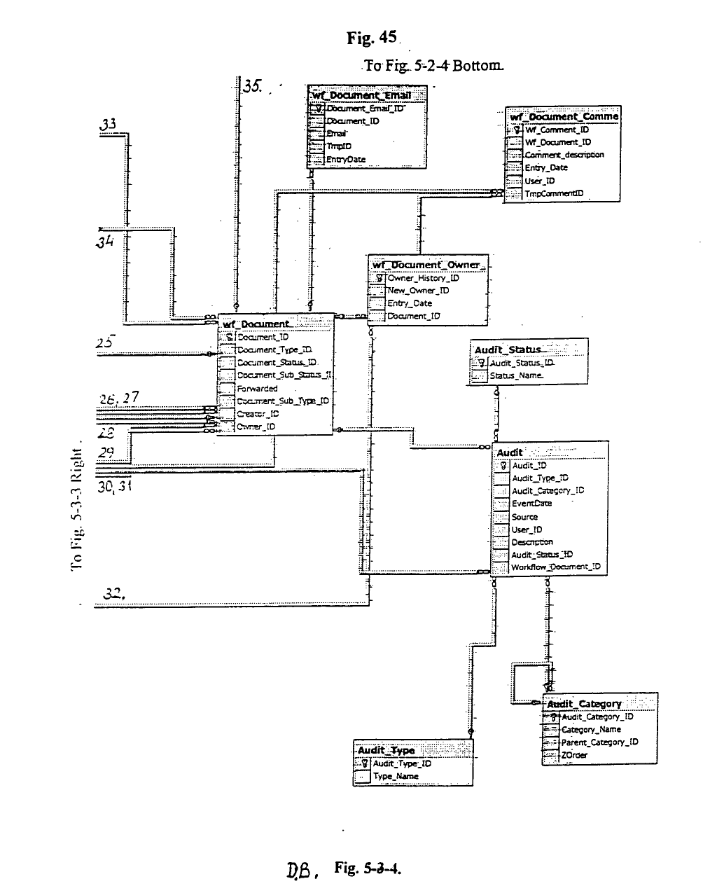

A database implemented according to some embodiment of the present invention is further described. The database schema shown on FIGS. 35 through 45 shows database objects (tables, primary and foreign key relationships) that may be used in some embodiments of the present invention. This database may support only some of the system operations, described in the previous sections. The normalization rules and foreign key relationships may be extensively used to improve or optimize data storage efficiency, referential integrity of the data, and database performance. It is understood, that this database schema is not the only possible database design supporting the functionality of embodiments of the present invention. Moreover, the database schema may be embodied as one or more relational/functional, centralized and/or distributed databases.

Referring to FIGS. 35 through 45:
“Bus”—contains the master listing of buses.
“Bus_Arrival”—used to store the information about bus arrival to the destination time and status.
“Bus_Arrival_Status”—lookup table of status values, linked with “Bus_Arrival”
“Bus_District”—implements many-to-many relationship between buses and districts
“Bus_Status”—lookup table of status values, linked with “Bus” table “Contact” stores contact information of system participants
“Contact_Type”—lookup table of contact types, linked with “Contact” tables
“County”—master list of counties
“District”—master list of school districts
“District_Contact”—provides a lookup of contact information to districts
“Groups”—used to store the listing of various user roles or user groups and to define the system access rights for groups of users
“Request”—stores information and status of different types of requests, including transportation requests, special needs request, field trip request.
“Request_Comment”—stores comments to requests supplied by system participants. Linked to “Request” table via one-to-many foreign key relationship
“Request_Status”—lookup table of request statuses, linked to a “Request” table
“Request_Transportation”—lookup table of transportation types, linked to a “Request” table
“Request_Type”—lookup table of transportation types, linked to a “Request” table
“Response”—stores responses to requests
“Response_Type”—lookup table storing types of responses, linked to a “Response” table
“Route”—master list of routes
“Run”—master list of runs, which constitute the routes
“Run_Status_Message”—stores messages about statuses of current runs
“School”—master list of schools
“School_Contact”—provides a lookup of contact information to schools
“School_District”—implements a many-to-many relationship between schools and districts
“School_Run”—implements a many-to-many relationship between schools and bus runs for this school
“School_Stop”—implements a many-to-many relationship between schools and bus stops for routes and runs servicing the school
“State”—contains master list of states
“Stop”—contains master list of bus stops
“Stop_Run”—implements a many-to-many relationship between bus stops and bus runs
“Student”—contains master list of all students for a given system implementation
“Student_Information”—stores additional student information, for example contact information
“Student_Transportation”
“Time_District”
“Transportation_Schedule”
“Transportation_Type”—stores the list of transportation types, providing multiple choice selections when filling out the Transportation Change Request form.
“User_Groups” is a cross-reference table implementing many-to-many relationship between the users and security groups
“Users” table contains the listing of all users authorized into the system, their names, passwords and expiration dates.
Workflow_Document—Relates a document such as a request or the report of an emergency to a workflow. This relationship determines which set of business rules will be applied to the document allowing complete flexibility for the processing of each document.
Workflow_Status—relates a workflow document to a status which represents an individual step in a workflow process. Status can be arranged in any order or configuration to create a new workflow document that represents a different workflow process.
Workflow_History—records every step that a document takes in a workflow process. Each record may contain, but is not limited to, time of the change from one status to another, user and/or terminal that made the change, and user/entity that will be responsible for the next step in the workflow process.
Workflow_Entity—records the entity that is associated to the document. This can be, but is not limited to, a school, transportation district, or a county. This differs from the person who is associated to the document.
   12) Conventional School Transportation Management Systems.

The participants of conventional school transportation systems may oftentimes have no efficient way to communicate accurate information related to a transportation process. This may equally pertain to bus routes, bus stops locations and times, student to bus stop assignments in the morning and in the afternoon, and/or to any transportation changes. A current schedule may be manually updated and may only be available as a printed hard copy. That copy may be sent to schools once in the beginning of the school semester, and it may be practically obsolete by the time it is delivered to schools and parents, since many changes and adjustments may happen within the first few weeks of school. The District Managers may do a great job communicating and working with Assistant Principles and Parents to attempt to ensure that no child is left behind, but the lack of basic information management tools may lead to an information shortage. In contrast, embodiments of the present invention can help make this effort be more dependable. The conventional process for making changes to a student's bus stop assignment is through a paper form that is filled out and faxed to the District Manager. Every school may come up with its own version of those forms, so the collected information is extremely dispersed and non-uniform. The responses are sent back via a US Mail or by fax from DM to AP and parents.

In the drawings and specification, there have been disclosed embodiments of the invention and, although specific terms are employed, they are used in a generic and descriptive sense only and not for purposes of limitation. The following claim is provided to ensure that the present application meets all statutory requirements as a priority application in all jurisdictions and shall not be construed as setting forth the scope of the present invention.

1. A method of online schoolchildren transportation management, storing data and providing real-time communication between main participants of schoolchildren transportation process, such as (but not limited to) school transportation officers, district, county and/or state transportation management, schoolchildren and/or parents, and/or school bus drivers via a Web based network, comprising at least one or combination of the following parts:
Transportation Change Request and Response part, which provides a framework for information flow between the main participants of transportation process about changes in bus schedules, bus routes, bus stops and assignments of students to busses;
Bus Schedule, Bus Routes, Bus Stop and Students Assignment Lookup part, which provides a framework for regular bus related information to flow between the main participants of transportation process;
Transportation Emergencies and Exceptions part which provides a framework for information about buses emergency situations to flow between the main participants;
Bus Stops Location Change/Additions part, which provides a framework for information, for the optimization of bus route and stop locations, to satisfy requests received to flow between main participants of transportation process;
Automatic Request/Response Notification part, providing a framework for automatic request/response notification of transportation changes to subscribed users;
Bus Arrival/Departure Information part, which provides a framework for information about arrival/departure times to/from a point on the route, for a chosen bus number to flow to subscribed participants of transportation process;
Management/Executive Reporting part, which provides a framework for information about performance data of chosen schools, routes, bus drivers, and districts managers to flow to subscribed participants of transportation process;
Field Trips Request/Response part, which provides a framework for information about field trip requests, and their status, to flow to the main participants of transportation process;
Special Needs/Handicapped part, which provides a framework for information about special needs/handicapped transportation requests, and their status, to flow to the main participants of transportation;
Front desk/Call Center Operator part, which provides a framework for incoming information about emergency/exceptions, miscellaneous requests, and complaints, to flow to the prescribed participants of transportation process;
wherein each part consists of functional sections combining steps (operations), that are performed on computer system.

2. A method according to claim 1 wherein all communications between participants are automatically monitored and reported to the management when the replies are past due.

3. An Online Schoolchildren Transportation Management System for implementation of Method according to claim 1, comprising at least the following interacting blocks:
A schoolchildren transportation management Network Server that is connected to a plurality of terminal devices of school transportation officers, district, county and/or state transportation management, schoolchildren and/or parents, and/or school bus drivers via a network,
Plurality of Terminal Devices, including:
Terminal Devices of school children or school children's parents [TDSP];
Terminal Devices of school transportation officers-Assistant Principals [TDAP];
Terminal Devices of district, county, state transportation management, such as School District Transportation Manager [TDDM] or County's School transportation Administrator or Superintendent [TDDA];
Terminal Devices of school bus drivers [TDBD];
Terminal device of Front Desk or Call Center Operator [TDFO];
Special Needs/Handicapped Special Needs Coordinator [TDSNC].
Network, providing real time communication between Network Server and Terminal Devices.

4. A Method according to claim 1 wherein the Transportation Change Request and Response part comprises at least one or combination of the following sections: General Request, New Student Request, Existing Student Request, Request Status Check, Request Modification or Cancellation, Request Approval/Denial, Request Approval.

5. A Method according to claim 4 wherein General Request section consists of the following steps (operations):
Transportation Change Request (TCR) for student is created either by TDSP or TDAP or TDDM. TDSP may route request to TDAP or directly to TDDM. If TDAP receives the TCR from TDSP, TDAP adds information and routes it to TDDM.
TCR changes status after being opened by TDDM.
TCR is prioritized and queued.
TDDM also can generate TCR for students based on phone call, fax email etc. This TCR is prioritized and queued the same way as previous one.
TDDM is processing TCR; TCR may be assigned one of the following statuses: Approved, Denied or Postponed/Pending.
If TCR is approved, TDDM adds comments and routes Response to originator(s); appropriate changes are stored in the database; originator(s) receives and reviews the Response, TCR is archived.
If TCR is denied, TDDM adds comments and routes Response to Originator.
Originator(s) receives and reviews the Response. If the request was denied, originator can appeal the decision. In that case originator generates Appeal Request and routes it to the TDDM, where the Appeal Request will be prioritized and queued.
TCR is automatically archived when TCR reaches a status of Approved or Declined and maintains that status for a time set by the user.

6. A Method according to claim 4 wherein New Students Request section consists of the following steps:
New Student request (NSR) is created either by TDSP, or TDAP, or TDDM.
TDSP fills in/imports New Student Information, adds comment and submits (routs) the Request to TDAP or directly to TDDM.
NSR is saved to Database Server.
If Request was routed to TDAP, TDAP adds comments and routes Request to TDDM. TDDM saves Request to Database Server.
Next continue with claim 10.
If NSR is created by TDDM, TDDM fills in/imports information and saves NSR to database.
After that NSR is placed into the queue along with all other requests.

7. A Method according to claim 4 wherein Existing Students Request section consists of the following steps:
Existing Student Request (ESR) is created either by TDSP, or TDAP, or TDDM. User searches database for existing student.
ESR is created based on existing student records, additional data and comment are entered by user.
TDSP submits ESR to TDAP or directly to TDDM. ESR will be saved to Server automatically.
TDAP adds comments and additional information to ESR. Then ESR is submitted to TDDM.
TDDM receives ESR (from TDSP or TDAP) and saves to database on Server.
If ESR is created by TDDM, it also is saved to database on Server.
Next continue with Claim item 9.

8. A Method according to claim 4 wherein Request Status Check section consists of the following steps:
Status of any request for transportation may be checked by TDSP, or TDAP, or TDDM. In all cases list of requests is retrieved from database on Server. Then user locates the request in the list, or uses “Find” feature to locate request, or uses filters to narrow down request list and then locate request in the list.
Request details are retrieved from database on Server.
Request information is displayed to user. User reviews status and details.

9. A Method according to claim 4 wherein Request Comments, Changes or Cancellations section consists of the following steps:
List of Requests is retrieved by any authenticated user from database on Server.
Then user locates the request in the list, or uses “Find” feature to locate request, or uses filters to narrow down request list and then locates request in the list.
Request details are retrieved from database on Server.
Request information is displayed to user.
If current Request status allows changes or cancellations, user makes changes or deletes Request. User adds comment(s). Changes are saved to database on Server.
If current Request status does not allow changes or cancellations, user can add a comment to Request. All comments are also saved to database on Server.

10. A Method according to claim 4 wherein Request Approval, Denial or Pending section consists of the following steps:
TDDM retrieves list of Requests from Database on Server.
Then user locates the request in the list, or uses “Find” feature to locate request, or uses filters to narrow down request list and then locate request in the list.
Request details are retrieved from database on Server.
Request information is displayed to user.
TDDM approves, or denies or postpones the request for bus stop location change/addition, student assignment to a stop or route, student removal from stop or route, or student movement from one stop or route to another
If Request is approved, user marks request as Approved and adds comments, after that the changes are saved to database on Server.
If Request is denied user marks request as Denied and adds comments.
Request and comments are routed to originator for review.
If user postpones with Request, request remains in the TDDM queue for processing later.

11. A Method according to claim 4 wherein Request Appeal section consists of the following steps:
TDSP or TDAP retrieves list of Requests from database on Server.
Then user locates the request in the list, or uses “Find” feature to locate request, or uses filters to narrow down request list and then locate request in the list.
Request details are retrieved from database on Server.
Appeal request is created based on the request information. Comment is added.
Appeal request is saved to database on server.
Appeal request is routed to TDDM.

12. A Method according to claim 1 wherein the Bus Related Information Lookup part comprises the following sections: Bus Route and Schedule Lookup, Bus Stops and Students Assignment Lookup by Route, Bus Stops and Student Assignment Lookup by Student Name, Bus Status/Delays/Emergencies Lookup.

13. A Method according to claim 12 wherein Bus Route and Schedule Lookup section consists of the following steps:
TDSP or TDAP or TDBD retrieves a list of Bus Routes from database on Server.
TDSP or TDAP or TDBD selects a specific Route.
Bus routes and schedule detailed information is retrieved from database on Server.
Bus route and schedule information is displayed to the user. Optionally, it can be printed.

14. A Method according to claim 12 wherein Bus Stops and Student Assignment Lookup by Route section consists of the following steps:
TDSP or TDAP or TDBD retrieves a list of Bus Routes from database on Server.
TDSP or TDAP or TDBD selects a specific Route.
TDSP or TDAP or TDBD retrieves Stops and Students for the selected Route from database on Server.
TDSP or TDAP or TDBD selects a specific Student or Stop.
Bus stop detailed information is displayed. Information about students assigned to selected stop is displayed. Optionally can be printed.

15. A Method according to claim 12 wherein Bus Stops and Student Assignment Lookup by Student Name section consists of the following steps:
TDSP or TDAP or TDBD retrieves list of names allowed for viewing by business rules from database on Server.
Then user can locate student's name in the list, or use “Find” feature to locate student's name, or use filters to narrow down student's name list and then locate student's name in the list.
Bus schedule, routes, bus stops and student assignment information for selected student is retrieved from database on Server.
Bus route and bus stop assignment for given student is displayed. Optionally can be printed.

16. A Method according to claim 12 wherein Bus Status/Delays/Emergencies Lookup section consists of the following steps:
TDSP or TDAP or TDDM retrieves bus route listing for given school from database on Server. (TDDM should preliminary select school.)
Then user can locate bus route in the list, or use “Find” feature to locate bus route, or use filters to narrow down bus route list and then locate bus route in the list.
Detailed information about bus status, delays, and emergencies for selected bus route is retrieved from database on Server.
Detailed information about bus status, delays, and emergencies for selected bus route is displayed. Optionally, it can be printed.

17. A Method according to claim 1 wherein the Transportation Emergencies and Exceptions part comprises the following sections: Bus Delay or Break down Information Entry, Bus Unexpected Detour Information Entry, and School Bus Involved in Traffic Accident Information Entry.

18. A Method according to claim 17 wherein Bus Delay or Break down Information Entry section consists of the following steps:
TDBD or TDDM or TDAP enters route number or selects route number from the list of routes.
User enters information about delay or brake down of the bus. Optionally, substitute bus number is entered.
The anticipated delay is entered by the TDBD or TDDM or TDAP.
In an automated mode, the bus position in route is automatically detected by Data Acquisition System. Time and position of bus in route is compared with expected time and position. Bus unexpected detour status is automatically detected by software sue to a difference in expected position and time and actual position and time.
Information is saved to database on Server.

19. A Method according to claim 17 wherein Bus Unexpected Detour Information Entry section consists of the following steps:
TDBD or TDDM or TDAP enters route number or selects route number from the list of routes.
User enters information about unexpected detour of the bus. Optionally, substitute bus number is entered.
The anticipated delay is entered by the TDBD or TDDM or TDAP.
Information is saved to database on Server.
In an automated mode, the bus position in route is automatically detected by Data Acquisition System. Time and position of bus in route is compared with expected time and position. Bus unexpected detour status is automatically detected by software sue to a difference in expected position and time and actual position and time.
Information is saved to the same database on Server.

20. A Method according to claim 17 wherein Bus School Bus Involved in Traffic Accident Information Entry section consists of the following steps:
TDDB or TDDM or TDAP enters route number or selects route from the list of routes.
User enters information about school bus involved into traffic accident. Optionally, substitute bus number is entered.
Information is saved to database on Server.

21. Method according to claim 1 wherein the Bus Stop Location Change/Addition part comprises the following sections: Bus Stop Location Change/Addition Selection, Bus Schedule/Student Assignment Change Automatic Notification.

22. Method according to claim 21 wherein the Bus Stop Location Change/Addition Selection section consists of the following steps:
This section starts just after request information was displayed to user (TDDM). (See claim 10)
User optimizes bus stop location (change or addition) base on analysis of all bus routes, bus stops, schedules and student assignments.
System picks the best solution. Suggested solution is displayed to user.
Information is saved to database on Server.
If user uses Alternative Data System, user transfers or exports request data to this Alternative Data System and uses this System to create bus stop/change bus stop location and assign student to a stop.
Changed data imported from Alternative Data System to database on Server and saved.
Request and Comments are routed to Originator for Review.

23. A Method according to claim 21 wherein the Bus Schedule/Student Assignment Change Automatic Notification section consists of the following steps:
Software on Server automatically detects bus stop location change, new bus stop creation, bus stop deletion, student to stop assignment change or bus route schedule change.
If there are any users subscribed for Notifications for this District, School, Route or Stop, Notification Server generates automatic Notification to all subscribed users.
Automatic Notification is routed to TDDSP, TDAP, TDDM, TDBD and/or additional devices, like phone, pager, email, fax etc.

24. A Method according to claim 1 wherein the Bus Automatic Request/Response Notification part comprises the following sections: Automatic Request Notification, Automatic Response Notification to TDAP, TDSP, TDBD.

25. A Method according to claim 24 wherein the Automatic Request Notification section consists of the following steps:
Software on Server Automatically Detects Creation of New Submitted Transportation Change Request or Addition of Comment to Previously Created Request.
If there are any users, subscribed for Request Notifications for this District or School, Notification Server generates automatic Notification to all users, subscribed for Notification.
Automatic Notification is routed to TDDM and/or Additional Devices, Like Phone, Pager, Email, Fax etc.

26. A Method according to claim 24 wherein the Automatic Response Notification to TDAP, TDSP, and TDBD section consists of the following steps:
Software on Server automatically detects the Response to submitted Transportation Change Request or Addition of Comment to previously created request.
If there are any users, subscribed for Response Notifications for this District or School, Notification Server generates automatic Notification to all users, subscribed for Notification for this District, School, route, and stop.
Automatic Notification is routed to TDSP, TDAP, TDDM and/or Additional Devices, Like Phone, Pager, Email, Fax etc.

27. A Method according to claim 1 wherein the Bus Arrival/Departure Information part comprises the following sections: Bus Arrival/Departure Information Entry, Bus Arrival/Departure Information Lookup.

28. A Method according to claim 27 wherein Bus Arrival/Departure Information Entry section consists of the following steps:
TDSP or TDBD or TDDM or TDAP enters bus number and bus arrival/departure time to/from a point of route. Alternatively, time is entered automatically.
Information is saved to database on server.
In automated mode, the bus arrival/departure time to/from a point on a route is automatically detected by Data Acquisition System and saved to database on Server.

29. A Method according to claim 27 wherein Bus Arrival/Departure Information Lookup section consists of the following steps:
TDSP or TDBD or TDDM or TDAP retrieves the list of routes for given school/district from database on Server.
User selects route(s) from the list or enters route(s). User enters time frame(s) of information lookup.
Bus arrival/departure information for specified route(s) and time frame(s) is retrieved from database on Server.
User selects point(s) of route(s) from the list, or enters point(s) of route(s).
Bus arrival/departure information for selected points is displayed to user.

30. A Method according to claim 1 wherein the Management/Executive Reporting part comprises the following sections: Bus Driver/Bus Route Performance Reporting, District Management Performance Reporting.

31. A Method according to claim 30 wherein Bus Driver/Bus Route Performance Reporting section consists of the following steps:
TDBD or TDDM or TDAP retrieves the list of bus drivers/routes for given school/district/county from database on Server.
User selects bus driver(s) or route(s) from the list, or enters bus driver(s) name(s) or route number(s). User enters time frame(s) of Information Lookup.
Performance data for specified bus driver(s), route(s) and time frame(s) is retrieved from database on Server.
Bus driver(s)/route(s) Performance Report is compiled and displayed to user.

32. A Method according to claim 30 wherein District Management Performance Reporting section consists of the following steps:
TDDM or TDDA (Terminal Device of District Administrator) or TDAP retrieves the list of district(s) for given County/State from database on Server.
User selects district(s) from List or enters the name of District. User enters reporting period(s).
Performance data for specified district(s) is retrieved from database on Server.
District Management Performance Report is compiled and displayed to user.

33. A Method according to claim 1 wherein the Field Trip Request and Response part comprises the following sections: Field Trip Request; Field Trip Request Approval, Denial or Pending Status; Field Trip Request Status Check.

34. A Method according to claim 33 wherein Field Trip Request section consists of the following steps:
TDAP fills in Field Trip Request Information Form, adds a Comment to Field Trip Request and Submit the Request (Routing to TDDM).
Request is saved to Database on Server.

35. A Method according to claim 33 wherein Field Trip Request Approval, Denial or Pending Status section consists of the following steps:
TDDM opens list of Field Trip Requests (Retrieves from Database on Server).
Then User locates Field Trip request in the List or uses “Find” feature to locate Field Trip Request or uses filters to Narrow dawn Request List (and then locate Field Trip). In all cases Field Trip Request details are retrieved from Database on Server and displayed to User.
If User approves Field Trip Request, TDDM marks it as approved, enters additional information/comments and saves Field Trip request to Database on server. Request and comments are routed to Originator for review.
If User denies Field Trip Request, the Request is marked as Denied; Additional comments are added to Request. Changes and comments are saved to database on Server. Request and comments are routed to Originator for review.
If User (TDDM) postpones/cancel Request, it remains in the queue for later processing.

36. A Method for the System according to claim 33 wherein Field Trip Request Status Check section consists of the following steps:
Originator (TDAP) retrieves List of Field Trip Requests from Database on Server.
User locates Field Trip Request in the List or uses “Find” feature to locate Field Trip Request or uses filters to narrow down Request List; then locates the Field Trip Request in the List.
Field Trip Request details are retrieves from Database on Server.
Field Trip Request Information is displayed to User. User reviews status and details.

37. A Method according to claim 1 wherein Special Needs/Handicapped Transportation Request and Response Part comprises of the following sections: Special Needs/Handicapped Transportation Request, Special Needs/Handicapped Transportation Approval, Denial or Pending Status, Special Needs/Handicapped Transportation Request Status Check and Special Needs/Handicapped Special Needs Coordinator Approval, Denial or Pending Status.

38. A Method according to claim 37, wherein Special Needs/Handicapped Transportation Request section consists of the following steps:
TDAP fills in Special Needs/Handicapped Transportation Request Information Form, adds comment and routes it to Special Needs Coordinator(s) and/or to TDDM for approval.
Electronic approval signature is saved to Database.
Submit the Request (routing) to TDDM.
Request saved to database on Server.

39. A Method according to claim 37, wherein section Special Needs/Handicapped Transportation Approval, Denial or Pending Status consists of the following steps:
TDDM retrieves the list of Special Needs/Handicapped Transportation Requests from Database on Server.
TDDM locates the Special Needs/Handicapped Transportation Requests, or uses “Find” feature to locate Special Needs/Handicapped Transportation Requests, or uses filters to narrow down Request List and then chooses desired Request. In all cases Special Needs/Handicapped Transportation Requests details are retrieves from Database and displayed to User.
If User approves this Special Needs/Handicapped Transportation Request, user marks it as approved and enters additional information and comments;
Changes are saved to database on Server.
If User denies Request, he/she marks it as denied and adds comments.
Changes are saved to Database on Server.
Request and comments are routed to Originator for review.
If User (TDDM) postpones/cancels the Request, it remains in the queue for later processing.

40. A Method according to claim 37, wherein section Special Needs/Handicapped Transportation Request Status Check consists of the following steps:
TDAP retrieves from Database on Server the list of Special Needs/Handicapped Transportation Requests and then either locates the desired Request in the list, or uses “Find” feature to locate the desired Request, or uses filters to narrow down Request list to locate the desired Special Needs/Handicapped Transportation Request in the list.
The details of Request are retrieved from Database to Server.
Special Needs/Handicapped Transportation Request Information are displayed to User. User reviews status and details.

41. A Method according to claim 37, wherein section Special Needs/Handicapped Special Needs Coordinator [TDSNC] Approval, Denial or Pending Status consists of the following steps:
TDAP or TDSNC retrieves list of Special Needs/Handicapped transportation requests from Database on Server.
Then either locates the desired request in the list, or uses “Find” feature to locate the desired Request, or uses filters to narrow down Request list and locate the desired Special Needs/Handicapped Transportation Request in the list.
Special Needs/Handicapped Transportation Request details are retrieved from database on Server.
Request information is displayed to the User.
If User approves this Special Needs/Handicapped Transportation Request, user marks it as approved, applies electronic signature. User enters additional information and comments;
Changes are saved to database on Server.
If User denies Request, he/she marks it as denied and adds comments.
Changes are saved to Database on Server.
Request and comments are routed to TDDM.
If User denies Request he/she marks Request as Denied. User adds comments.
Changes are saved to Database on Server.
Request and Comments are routed to request Originar.
If User (TDDM) postpone/cancel the Request, it remains in the queue for later processing.

42. A Method according to claims 1 wherein Front Desk Operator or Call Center part consists of the following steps:
Front Desk Operator or Call Center may receive Incoming Phone Call, or Incoming Fax, or Incoming E-mail, or Incoming Postage.
Incoming call or miscellaneous Request is logged into TDFO and saved into the database.
Emergency or exception information is sent to all involved transportation participants according to current business rules via notification Server.
Other miscellaneous request is routed to appropriate party, prioritized and queued for processing.
Complaint is routed to appropriate party for the follow-up. Logged to the database for audits.

43. Online Schoolchildren Transportation Management System according to claim 3 wherein the Network Server includes at least one computer running a set of server applications such as but not limited to:
Web Server, such as Microsoft Internet Information Server 5.0, that configured to support two way communications, for example via HTTP or secure HTTPS protocols to the browsers on client terminal devices.;
Database Server, such as Microsoft SQL Server 2000 or Oracle 8, that is responsible for storing information used by system, such as the data about transportation process participants, transportation changes requests, schools, school bus routes and runs, bus stops, student assignments to bus stops, schedules;
Notification Server, that is configured to support messaging and notification activities, such as emails, SMS messages, messages to pager or generate postal correspondence delivered via US Mail or other commercial mail carriers;
Application Server will run miscellaneous support and delivery programs which include but are not limited to the applications that display the information received from the database server on the [TDSP], [TDAP], [TDDM], [TDDA], applications that track Bus position, and applications that monitor request status changes.
Interactive Voice response (1VR) Server, is responsible for two-way communication via public telephone lines with clients using phones as terminal devices; the IVR server can use text-to-speech technology for outbound information and speech recognition or touch tone for inbound information;
Reporting Server is used to generate reports and deliver them to recipients.

44. A Computer Program Product for the implementation of a Method according to claim 1, comprising a computer usable storage medium having computer readable program code embodied in the medium, wherein the computer readable program code comprises of at least one or a combination of the following:
Computer readable program code that stores, retrieves and displays a plurality of Schoolchildren Transportation Management System User's data, including Schools, School officials, District and County Transportation Officers, Logins, and Passwords; Schoolchildren data (personal and assignment to bus stops); School bus run and route data including bus stops, time of arrival/departure to every stop.
Computer readable program code that permits selected users to create and process transportation change requests/responses for new students, existing students, request status check, request comments, changes or cancellations.
Computer readable program code that permits selected users to create and process requests/responses for special needs/handicapped students transportation, check and appeals.
Computer readable program code that permits selected users to create and process field trip requests/response, check and appeals.
Computer readable program code that offers user either to locate student name in the list, or use “Find” feature to locate student name in the list, or use filters to narrow down student name list and then locate student name in the list.
Computer readable program code that permits TDDM to accept, decline or postpone Transportation Change Request and Response.
Computer readable program code that permits Request Originator to create a Request or Request Appeal.
Computer readable program code that automatically detects in real time bus positions in the routs and bus delay and compare it with expected time and position and send appropriate messages to certain users according to mailing list.
Computer readable program code that creates the special forms for users to enter information about bus detour, delays, involvement into traffic accident, substitute bus number and send this information to certain users according to mailing list.
Computer readable program code that automatically detects creation of new submitted transportation change requests or addition of comments to previously created requests and routes automatic notification to all users subscribed for notification for this district or school.
Computer readable program code that automatically detects the response to submitted transportation change request or addition of comments to previously responded response to requests and sends automatic notification to all users subscribed for notification for this school, routes and sops.
Computer readable program code that electronically sends E-mails to inform parents about an incoming School bus.
Computer readable program code that automatically detects bus stop location changes, new bus stop creation, bus stop deletion, students to bus stop assignment change, bus route schedule change and sends automatic notification to all users subscribed for notification (TDDM, TDAP, TDSP, TDBD and/or additional devices like phone, pager, Email, fax etc.) for this district, school, route and stop.
Computer readable program code that according to request of subscribed users retrieves, compiles and displays performance data (report) for selected bus drivers, routes or district managements for chosen district, county, school.
Computer readable program code that logs incoming calls or miscellaneous requests (incoming faxes, incoming Emails, incoming postages to TDFO, saves them into the Database and permits operator to separate emergency/exception information, from other miscellaneous requests, or complaints). All information is routed to appropriate party according to current business rules via notification server, prioritized and queued for processing.
